(19) United States
(12) Patent Application Publication
(10) Pub. No.: US 2025/0327948 A1
(43) Pub. Date: Oct. 23, 2025

(54) COMPOSITE MATERIALS AND METHODS OF MAKING AND USE THEREOF

(71) Applicant: BOARD OF REGENTS, THE UNIVERSITY OF TEXAS SYSTEM

(72) Inventors: Vijay Anirudh PREMNATH, Austin, TX (US); Chih-Hao CHANG, Austin, TX (US); I-Te CHEN, Austin, TX (US)

(21) Appl. No.: 18/868,020

(22) PCT Filed: May 26, 2023
(86) PCT No.: PCT/US2023/023671

§ 371 Date: Nov. 21, 2024

Related U.S. Application Data
(60) Provisional application No. 63/347,195, filed on May 31, 2022.

(51) Int. Cl. G02B 1/00; B82Y 20/00; B82Y 30/00; B82Y 40/00

(52) U.S. Cl. CPC G02B 1/005; B82Y 30/00; B82Y 20/00; B82Y 40/00; G02B 2207/101; G02B 2207/107

(57) ABSTRACT

Disclosed herein are composite materials and methods of making and use thereof. The composite materials can comprise: a porous periodic nanolattice layer having a first refractive index, and a continuous layer having a second refractive index and being disposed on the porous periodic nanolattice layer; the first refractive index and the second refractive index being different; wherein the porous periodic nanolattice layer comprises a plurality of pores defined by a nanolattice formed of hollow members, the plurality of pores being periodic. Also disclosed herein are methods of making a composite material, the methods comprising: forming a patterned layer; depositing a first material on the patterned layer, thereby forming a coated patterned layer; depositing a buffer material layer on the coated patterned layer, thereby forming a planarized layer; depositing a continuous layer on the planarized layer; and removing the buffer material layer and the patterned layer, thereby forming the composite material.

### CROSS-REFERENCE TO RELATED APPLICATIONS

This application claims the benefit of priority to U.S. Provisional Application No. 63/347,195 filed May 31, 2022, which is hereby incorporated herein by reference in its entirety.

### STATEMENT OF GOVERNMENT SUPPORT

This invention was made with government support under Grant No. CMMI1552424 awarded by the National Science Foundation. The government has certain rights in the invention.

### BACKGROUND

The advent of nanofabrication has opened tremendous opportunities for acoustics, photonics, and electronics industries, enabling mass manufacturing of materials having superior properties than bulk, and exhibiting unexpected effects due to scaling laws. The presence of periodic nanostructures can further amplify the effects due to their ordered geometry.

Photonic crystals have a periodic dielectric profile and can prevent propagation of light with certain wavelengths in specific polarization directions in the crystal.

There currently is an absence of multilayer photonic crystals with high/low index mismatch. Further, there is a lack of integration of solid layers in multilayer 3D stacked structures. The compositions, devices, methods, and systems discussed herein address these and other needs.

### SUMMARY

In accordance with the purposes of the disclosed compositions, devices, methods, and systems as embodied and broadly described herein, the disclosed subject matter relates to composite materials and methods of making and use thereof.

For example, described herein are composite materials comprising: a porous periodic nanolattice layer; and a continuous layer; wherein the continuous layer is disposed on the porous periodic nanolattice layer; wherein the porous periodic nanolattice layer has a first refractive index and the continuous layer has a second refractive index; wherein the first refractive index and the second refractive index are different; wherein the porous periodic nanolattice layer comprises a plurality of pores defined by a nanolattice formed of hollow members, the plurality of pores being periodic (e.g., arranged in an ordered array).

In some examples, the first refractive index is from 1 to 1.35. In some examples, the second refractive index is from 1 to 4. In some examples, the difference between the first refractive index and the second refractive index is 0.5 or more, 1 or more, or 2 or more.

In some examples, the porous periodic nanolattice layer has a porosity of 90% or more or 95% or more. In some examples, the plurality of pores have an average pore size of from 10 nanometers (nm) to 1 micrometer (μm). In some examples, the plurality of pores have a periodicity of from 1 nanometer (nm) to 1 micrometer (μm).

In some examples, the hollow members comprise a wall defining an interior void space. In some examples, the wall comprises a dielectric material, a metal, or a combination thereof. In some examples, the wall comprises a metal oxide. In some examples, the wall comprises Al₂O₃, ZnO, SiO₂, TiO₂, or a combination thereof. In some examples, the wall comprises Al₂O₃. In some examples, the wall has an average thickness of from 1 nanometer (nm) to 250 nm. In some examples, the wall has an average thickness of from 1 nm to 100 nm, from 5 nm to 75 nm, or from 10 nm to 50 nm. In some examples, the wall further comprises a first dopant.

In some examples, the porous periodic nanolattice layer has an average thickness of from 1 nanometer (nm) to 1 micrometer (μm). In some examples, the porous periodic nanolattice layer has a mechanical stiffness sufficient to support the continuous layer.

In some examples, the continuous layer comprises a dielectric material, a metal, or a combination thereof. In some examples, the continuous layer comprises a metal oxide. In some examples, the continuous layer comprises TiO₂, Al₂O₃, ZnO, or a combination thereof. In some examples, the continuous layer has an average thickness of from 1 nanometer (nm) to 1 micrometer (μm). In some examples, the continuous layer has an average thickness of from 10 nm to 500 nm, from 50 nm to 250 nm, or from 50 nm to 100 nm. In some examples, the continuous layer further comprises a second dopant. In some examples, the continuous layer has a mechanical stiffness sufficient to support the porous periodic nanolattice layer.

In some examples, the composite material further comprises a substrate, wherein the porous periodic nanolattice layer is disposed on the substrate, such that the porous periodic nanolattice layer is sandwiched between the substrate and the continuous layer.

In some examples, the composite material further comprises a substrate, wherein the continuous layer is disposed on the substrate, such that the continuous layer is sandwiched between the substrate and the porous periodic nanolattice layer.

In some examples, the composite material further comprises one or more additional layers disposed on the porous periodic nanolattice layer, such that that the porous periodic nanolattice layer is sandwiched between the continuous layer and the one or more additional layers.

In some examples, the composite material further comprises one or more additional layers disposed on the continuous layer, such that the continuous layer is sandwiched between the porous periodic nanolattice layer and the one or more additional layers.

In some examples, the continuous layer and/or the porous periodic nanolattice layer independently have a mechanical stiffness sufficient to support the one or more additional layers.

In some examples, each of the one or more additional layers comprises a material having a refractive index, and the refractive index of a given layer is different than the refractive index of the preceding layer and/or subsequent layer. In some examples, each of the one or more additional layers independently has an average thickness of from 1 nanometer (nm) to 1 micrometer (μm).

In some examples, the composite material comprises a stack comprising a plurality of alternating layers of the porous periodic nanolattice layer and the continuous layer.

In some examples, the composite material has a total number of layers of from 2 to 100.

In some examples, the total number of layers is 2 or more. In some examples, the total number of layers is 4 or more, 6 or more, or 8 or more.

In some examples, the composite material comprises a Bragg reflector. In some examples, the composite material comprises a one-dimensional photonic crystal.

In some examples, the composite material reflects one or more wavelengths of the solar spectrum with a reflectivity of 80% or more. In some examples, the composite material has an average specular reflectance of 80% or more over at least a portion of the solar spectrum. In some examples, the composite material has a reflectance peak and the FWHM of the reflectance peak is 300 nm or more.

In some examples, the composite material is a low k dielectric. In some examples, the composite material has a low thermal conductivity, a low refractive index, a low stiffness, or a combination thereof.

Also disclosed herein are methods of making any of the composite materials disclosed herein.

Also disclosed herein are methods of making a composite material, the methods comprising: (a) forming a patterned layer; (b) depositing a first material on the patterned layer, thereby forming a coated patterned layer; (c) depositing a buffer material layer on the coated patterned layer, thereby forming a planarized layer; (d) depositing a continuous layer on the planarized layer; and (e) removing the buffer material layer and the patterned layer, thereby forming the composite material; wherein the composite material comprises: a porous periodic nanolattice layer; and a continuous layer; wherein the continuous layer is disposed on the porous periodic nanolattice layer; wherein the porous periodic nanolattice layer has a first refractive index and the continuous layer has a second refractive index; wherein the first refractive index and the second refractive index are different; and wherein the porous periodic nanolattice layer comprises a plurality of pores defined by a nanolattice formed of hollow members, the plurality of pores being periodic (e.g., arranged in an ordered array).

In some examples, the methods further comprise repeating steps (a) to (d) one or more times before performing removing step (e).

In some examples, the methods further comprise depositing one or more additional layers before performing removing step (e).

In some examples, the composite material made by the methods disclosed herein comprises any of the composite materials disclosed herein.

In some examples, forming the patterned layer comprises 3D nanolithography, nanosphere lithography, phase-shift lithography, holographic lithography, an additive manufacturing process, an imprint process, a self-assembly process, or a combination thereof. In some examples, forming the patterned layer comprises nanosphere lithography, near-field phase-shift lithography, or a combination thereof.

In some examples, forming the patterned layer comprises: depositing a photoresist layer; forming a monolayer of nanospheres on the photoresist layer; irradiating the monolayer of nanospheres with light configured to pattern the photoresist layer; and removing the nanospheres. In some examples, the photoresist layer is deposited using spin coating, drop-casting, zone casting, dip coating, blade coating, spraying, vacuum filtration, or combinations thereof. In some examples, the photoresist layer is deposited on a substrate. In some examples, the substrate further comprises an antireflection layer and the method comprises depositing the photoresist layer on the antireflection layer. In some examples, the nanospheres comprise a polymer, a dielectric material, a metal oxide, a metal, or a combination thereof. In some examples, the nanospheres have an average diameter of from 1 nm to 1 μm. In some examples, the nanospheres have an average diameter of from 100 nm to 1 μm, from 100 nm to 750 nm, or from 300 nm to 500 nm. In some examples, the monolayer of nanospheres formed via self-assembly, Langmuir-Blodgett deposition, dip coating, spin coating, solvent evaporation, force-assembly methods, air-water interface methods, blade coating, or a combination thereof. In some examples, the light comprises UV light.

In some examples, the first material is deposited using electroplating, lithographic deposition, electron beam deposition, thermal deposition, chemical vapor deposition (CVD), atomic layer deposition (ALD), physical vapor deposition (PVD), sputtering, pulsed layer deposition, molecular beam epitaxy, evaporation, or combinations thereof. In some examples, the first material is deposited using atomic layer deposition (ALD).

In some examples, the buffer material layer is deposited using spin coating, drop-casting, zone casting, dip coating, blade coating, spraying, vacuum filtration, or combinations thereof.

In some examples, the continuous layer is deposited using electroplating, lithographic deposition, electron beam deposition, thermal deposition, chemical vapor deposition (CVD), atomic layer deposition (ALD), physical vapor deposition (PVD), sputtering, pulsed layer deposition, molecular beam epitaxy, evaporation, or combinations thereof. In some examples, the continuous layer is deposited using atomic layer deposition (ALD).

In some examples, the removing step comprises a thermal cycle, plasma etching, wet etching, solvent removal, or a combination thereof.

Also disclosed herein are methods of use of any of the composite materials disclosed herein and/or any of the composite materials made by any of the methods disclosed herein. In some examples, the method comprises using the composite material in an optical device, an electronic device, or an optoelectronic device. In some examples, the method comprises using the composite material in a photonic application, an electronic application, a thermal application, or a combination thereof. In some examples, the method comprises using the composite material as a photonic crystal, as a dielectric mirror, for thermal isolation, for selective reflection, or a combination thereof. In some examples, the method comprises using the composite material as a Bragg reflector, an electric insulator, a thermal insulator, or a combination thereof. In some examples, the method comprises using the composite material in a mechanical device, an energy dissipation device, an energy storage device, a spring system, or a combination thereof. In some examples, the method comprises using the composite material in a filter device.

Also disclosed herein are articles of manufacture and/or a devices comprising any of the composite materials disclosed herein and/or any of the composite materials made by any of the methods disclosed herein. In some examples, the article and/or device comprises an optical device, an electronic device, or an optoelectronic device. In some examples, the article and/or device comprises a photonic crystal, a dielectric mirror, a Bragg reflector, or a combination thereof. In some examples, the article and/or device comprises a mechanical device, an energy dissipation device, an energy storage device, a spring system, or a combination thereof. In some examples, the article and/or device comprises a filter device.

Additional advantages of the disclosed compositions, devices, systems, and methods will be set forth in part in the description which follows, and in part will be obvious from the description. The advantages of the disclosed compositions, devices, systems, and methods will be realized and attained by means of the elements and combinations particularly pointed out in the appended claims. It is to be understood that both the foregoing general description and the following detailed description are exemplary and explanatory only and are not restrictive of the disclosed compositions, devices, systems, and methods, as claimed.

The details of one or more embodiments of the invention are set forth in the accompanying drawings and the description below. Other features, objects, and advantages of the invention will be apparent from the description and drawings, and from the claims.

### BRIEF DESCRIPTION OF THE FIGURES

The accompanying figures, which are incorporated in and constitute a part of this specification, illustrate several aspects of the disclosure, and together with the description, serve to explain the principles of the disclosure.

FIG. 1. Rigorous coupled-wave analysis simulation of the reflectance from 400 nm to 3.4 μm wavelength for the dielectric mirrors with repeated pairs.

FIG. 2. Rigorous coupled-wave analysis simulation of the reflectance from 0 up to 13 μm wavelength for the dielectric mirrors with repeated pairs.

FIG. 3. Rigorous coupled-wave analysis simulation of the reflectance from 400 nm to 3.4 μm wavelength for the dielectric mirrors with 3 repeated pairs.

FIG. 4. Rigorous coupled-wave analysis simulation of the reflectance from 0 up to 13 μm wavelength for the dielectric mirrors with 3 repeated pairs.

FIG. 5. Fabrication process of the dielectric mirror. (a) Nanostructures patterning process. (b) ALD process. (c) Buffer layer coating process. (d) High-index layer deposition process. (c) Repeat previous processes to build multilayer stacks. (f) Remove the photoresist and buffer layer.

FIG. 6. Cross-sectional SEM image of one pair of 180/80 nm Al₂O₃ nanolattice/TiO₂ stack.

FIG. 7. Cross-sectional SEM image of one pair of 300/135 nm Al₂O₃ nanolattice/TiO₂ stack. Scale bar=500 nm.

FIG. 8. Cross-sectional SEM image of one pair of 500/220 nm Al₂O₃ nanolattice/TiO₂ stack. Scale bar=500 nm.

FIG. 9. Cross-sectional SEM image of two pairs of 180/80 nm Al₂O₃ nanolattice/TiO₂ stack.

FIG. 10. Cross-sectional SEM image of two pairs of 300/135 nm Al₂O₃ nanolattice/TiO₂ stack. Scale bar=1 μm.

FIG. 11. Cross-sectional SEM image of two pairs of 500/220 nm Al₂O₃ nanolattice/TiO₂ stack. Scale bar=1 μm.

FIG. 12. Cross-sectional SEM image of three pairs of 180/80 nm Al₂O₃ nanolattice/TiO₂ stack. Scale bar=1 μm.

FIG. 13. Cross-sectional SEM image of three pairs of 300/135 nm Al₂O₃ nanolattice/TiO₂ stack. Scale bar=1 μm.

FIG. 14. Cross-sectional SEM image of three pairs of 500/220 nm Al₂O₃ nanolattice/TiO₂ stack. Scale bar=1 μm.

FIG. 15. Measured refraction index of the nanolattice and TiO₂ layer.

FIG. 16. TE mode specular reflectance at 532 nm of the 180/80 nm Al₂O₃/TiO₂ dielectric reflectors.

FIG. 17. TM mode specular reflectance at 532 nm of the 180/80 nm Al₂O₃/TiO₂ dielectric reflectors.

FIG. 18. TE mode specular reflectance at 633 nm of the 180/80 nm Al₂O₃/TiO₂ dielectric reflectors.

FIG. 19. TM mode specular reflectance at 633 nm of the 180/80 nm Al₂O₃/TiO₂ dielectric reflectors.

FIG. 20. Broadband specular reflectance under normal incidence of the 180/80 nm Al₂O₃/TiO₂ dielectric reflector with one pair of the repeating unit.

FIG. 21. Broadband specular reflectance under normal incidence of the 180/80 nm Al₂O₃/TiO₂ dielectric reflector with two pairs of the repeating unit.

FIG. 22. Broadband specular reflectance under normal incidence of the 180/80 nm Al₂O₃/TiO₂ dielectric reflector with three pairs of the repeating unit.

FIG. 23. Broadband specular reflectance of the 180/80 nm Al₂O₃/TiO₂ dielectric reflectors under normal incidence for broadband spectrum.

FIG. 24. Broadband specular reflectance of the 300/135 nm Al₂O₃/TiO₂ dielectric reflectors under normal incidence for broadband spectrum.

FIG. 25. Broadband specular reflectance of the 500/220 nm Al₂O₃/TiO₂ dielectric reflectors under normal incidence for broadband spectrum.

FIG. 26. Cross-sectional SEM image of the defects in a dielectric mirror with three repeating units of 300/135 nm pair.

FIG. 27. Cross-sectional SEM image of the defects in a dielectric mirror with three repeating units of 500/220 nm pair. Scale bar=1 μm.

FIG. 28. Schematic of fabrication process for the alternating nanolattice and film for multilayer reflector. (a) Spin-coat ARC and PR and assemble nanosphere (500 nm). (b) Normal exposure using 325 nm UV lithography. (c) Development followed by ALD. (d) Planarization and solid layer deposition using electron beam evaporation.

FIG. 29. SEM image of a sample with 130 nm thickness of PR, subjected to lithography with 325 nm UV laser at dose of 100 mJ/cm².

FIG. 30. Cross-sectional SEM image of Al₂O₃ nanolattice with thickness of 130 nm and TiO₂ film with thickness of 80 nm deposited using electron beam evaporation.

FIG. 31. SEM image of patterned photoresist showing shape defects and point defects.

FIG. 32. SEM image of patterned photoresist.

FIG. 33. Schematic diagram of multilayer stack with inverse opal structures.

FIG. 34. SEM image of multilayer stack with single layer inverse opal structures.

FIG. 35. SEM image of multilayer stack with single layer inverse opal structures.

FIG. 36. SEM image of multilayer stack with double layer inverse opal structure.

FIG. 37. SEM image of multilayer stack with triple layer inverse opal structure.

FIG. 38. SEM image of multilayer stack with quadruple layer inverse opal structure.

FIG. 39. SEM image showing formation of cracks.

FIG. 40. SEM image showing formation of cracks.

FIG. 41. SEM image showing formation of cracks.

FIG. 42. SEM image showing formation of cracks.

FIG. 43. SEM image showing exposed resist.

FIG. 44. SEM image showing crack forms on surface.

FIG. 45. SEM image of a single layer sample.

FIG. 46. SEM image of a double layer sample.

FIG. 47. SEM image of a triple layer sample.

FIG. 48. Broadband specular reflectance of the 180/80 nm Al₂O₃/TiO₂ dielectric reflectors under normal incidence with one pair of the repeating unit, two pairs of the repeating unit, and three pairs of the repeating unit was measured experimentally and modeled using rigorous coupled-wave analysis (RCWA).

FIG. 49. (Left) Representative illustration of the nanostructure on Silicon wafer, with specified period and different refractive indices for different composing materials. (Right) Isotropic thin film with an effective refractive index across the three orthogonal directions.

FIG. 50. Top view depicting the formation of desired nanostructures, and the resultant structure from the hexagonal closed packaging of nano spherical particles.

FIG. 51. Cross section view of the structure that represents the porous nano cylindrical structures with air between the approximately 21 nm thick walls of structures to reduce effective refractive index for 390 nm.

FIG. 52. Cross section view of 500 nm diameter phase mask sample.

FIG. 53. Cross section view of 390 nm diameter sphere phase mask sample.

FIG. 54. Low magnification view of nanolattices with 800 nm tall structures for 750 nm diameter spheres used in the phase masks.

FIG. 55. Variation in index with wavelength of ellipsometry source.

FIG. 56. Graphical representations of change in refractive index with number of cycles of ALD (thickness in Angstroms) for 750 nm, 500 nm and 390 nm phase masks, compared with experimental data for 500 nm spheres.

### DETAILED DESCRIPTION

The compositions, devices, methods, and systems described herein may be understood more readily by reference to the following detailed description of specific aspects of the disclosed subject matter and the Examples included therein.

Before the present compositions, devices, methods, and systems are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

In this specification and in the claims that follow, reference will be made to a number of terms, which shall be defined to have the following meanings.

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such components, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

“Exemplary” means “an example of” and is not intended to convey an indication of a preferred or ideal embodiment. “Such as” is not used in a restrictive sense, but for explanatory purposes.

Values can be expressed herein as an “average” value. “Average” generally refers to the statistical mean value.

By “substantially” is meant within 5%, e.g., within 4%, 3%, 2%, or 1%.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

As used herein the term “plurality” means 2 or more (e.g., 3 or more; 4 or more; 5 or more; 10 or more; 15 or more; 20 or more; 25 or more; 30 or more; 40 or more; 50 or more; 75 or more; 100 or more; 150 or more; 200 or more; 250 or more; 300 or more; 400 or more; 500 or more; 750 or more; 1000 or more; 1500 or more; 2000 or more; 2500 or more; 3000 or more; 4000 or more; or 5000 or more).

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

“Phase,” as used herein, generally refers to a region of a material having a substantially uniform composition which is a distinct and physically separate portion of a heterogeneous system. The term “phase” does not imply that the material making up a phase is a chemically pure substance, but merely that the chemical and/or physical properties of the material making up the phase are essentially uniform throughout the material, and that these chemical and/or physical properties differ significantly from the chemical and/or physical properties of another phase within the material. Examples of physical properties include density, thickness, aspect ratio, specific surface area, porosity, and dimensionality. Examples of chemical properties include chemical composition.

By “continuous” is meant a phase such that all points within the phase are directly connected, so that for any two points within a continuous phase there exists a path which connects the two points and does not leave the phase.

By “hollow” is meant when two void phases are completely separated by a third continuous phase that prevents any direct contact between the two void phases.

A “bicontinuous” material contains two separate continuous phases such that each phase is continuous, and in which the two phases are interpenetrating. It is impossible to separate the two structures without tearing one of the structures.

### Composite Materials

Disclosed herein are composite materials comprising: a porous periodic nanolattice layer; and a continuous layer; wherein the continuous layer is disposed on (e.g., fabricated or grown on) the porous periodic nanolattice layer; wherein the porous periodic nanolattice layer has a first refractive index and the continuous layer has a second refractive index; wherein the first refractive index and the second refractive index are different.

For example, the first refractive index can be 1 or more (e.g., 1.01 or more, 1.02 or more, 1.03 or more, 1.04 or more, 1.05 or more, 1.06 or more, 1.07 or more, 1.08 or more, 1.09 or more, 1.10 or more, 1.11 or more, 1.12 or more, 1.13 or more, 1.14 or more, 1.15 or more, 1.16 or more, 1.17 or more, 1.18 or more, 1.19 or more, 1.20 or more, 1.21 or more, 1.22 or more, 1.23 or more, 1.24 or more, 1.25 or more, 1.26 or more, 1.27 or more, 1.28 or more, 1.29 or more, 1.3 or more, 1.31 or more, 1.32 or more, 1.33 or more, 1.34 or more, 1.35 or more, 1.36 or more, 1.37 or more, 1.38 or more, or 1.39 or more). In some examples, the first refractive index can be 1.4 or less (e.g., 1.39 or less, 1.38 or less, 1.37 or less, 1.36 or less, 1.35 or less, 1.34 or less, 1.33 or less, 1.32 or less, 1.31 or less, 1.30 or less, 1.29 or less, 1.28 or less, 1.27 or less, 1.26 or less, 1.25 or less, 1.24 or less, 1.23 or less, 1.22 or less, 1.21 or less, 1.20 or less, 1.19 or less, 1.18 or less, 1.17 or less, 1.16 or less, 1.15 or less, 1.14 or less, 1.13 or less, 1.12 or less, 1.11 or less, 1.10 or less, 1.09 or less, 1.08 or less, 1.07 or less, 1.06 or less, 1.05 or less, 1.04 or less, 1.03 or less, or 1.02 or less). The first refractive index can range from any of the minimum values described above to any of the maximum values described above. For example, the first refractive index can be from 1 to 1.35 (e.g., from 1 to 1.2, from 1.2 to 1.4, from 1 to 1.1, from 1.1 to 1.2, from 1.2 to 1.3, from 1.3 to 1.4, from 1 to 1.05, from 1.05 to 1.10, from 1.10 to 1.15, from 1.15 to 1.20, from 1.20 to 1.25, from 1.25 to 1.30, from 1.30 to 1.35, from 1.35 to 1.4, from 1 to 1.35, from 1 to 1.30, from 1 to 1.25, from 1 to 1.2, from 1 to 1.15, from 1.02 to 1.4, from 1.03 to 1.4, from 1.04 to 1.4, from 1.05 to 1.4, from 1.06 to 1.4, from 1.07 to 1.4, from 1.08 to 1.4, from 1.09 to 1.4, from 1.10 to 1.4, from 1.15 to 1.4, from 1.02 to 1.35, from 1.02 to 1.3, from 1.02 to 1.2, or from 1.02 to 1.1).

In some examples, the second refractive index can be 1 or more (e.g., 1.01 or more, 1.02 or more, 1.03 or more, 1.04 or more, 1.05 or more, 1.06 or more, 1.07 or more, 1.08 or more, 1.09 or more, 1.10 or more, 1.11 or more, 1.12 or more, 1.13 or more, 1.14 or more, 1.15 or more, 1.16 or more, 1.17 or more, 1.18 or more, 1.19 or more, 1.20 or more, 1.21 or more, 1.22 or more, 1.23 or more, 1.24 or more, 1.25 or more, 1.26 or more, 1.27 or more, 1.28 or more, 1.29 or more, 1.3 or more, 1.31 or more, 1.32 or more, 1.33 or more, 1.34 or more, 1.35 or more, 1.36 or more, 1.37 or more, 1.38 or more, 1.39 or more, 1.4 or more, 1.45 or more, 1.5 or more, 1.55 or more, 1.6 or more, 1.65 or more, 1.7 or more, 1.75 or more, 1.8 or more, 1.85 or more, 1.9 or more, 1.95 or more, 2 or more, 2.1 or more, 2.2 or more, 2.3 or more, 2.4 or more, 2.5 or more, 2.75 or more, 3 or more, 3.25 or more, 3.5 or more, or 3.75 or more). In some examples, the second refractive index can be 4 or less (e.g., 3.75 or less, 3.5 or less, 3.25 or less, 3 or less, 2.75 or less, 2.5 or less, 2.4 or less, 2.3 or less, 2.2 or less, 2.1 or less, 2 or less, 1.95 or less, 1.9 or less, 1.85 or less, 1.8 or less, 1.75 or less, 1.7 or less, 1.65 or less, 1.6 or less, 1.55 or less, 1.5 or less, 1.45 or less, 1.4 or less, 1.39 or less, 1.38 or less, 1.37 or less, 1.36 or less, 1.35 or less, 1.34 or less, 1.33 or less, 1.32 or less, 1.31 or less, 1.30 or less, 1.29 or less, 1.28 or less, 1.27 or less, 1.26 or less, 1.25 or less, 1.24 or less, 1.23 or less, 1.22 or less, 1.21 or less, 1.20 or less, 1.19 or less, 1.18 or less, 1.17 or less, 1.16 or less, 1.15 or less, 1.14 or less, 1.13 or less, 1.12 or less, 1.11 or less, 1.10 or less, 1.09 or less, 1.08 or less, 1.07 or less, 1.06 or less, 1.05 or less, 1.04 or less, 1.03 or less, or 1.02 or less). The second refractive index can range from any of the minimum values described above to any of the maximum values described above. For example, the first refractive index can be from 1 to 4 (e.g., from 1 to 2.5, from 2.5 to 4, from 1 to 2, from 2 to 3, from 3 to 4, from 1 to 3.5, from 1 to 3, from 1 to 2.5, from 1 to 2, from 1 to 1.9, from 1 to 1.8, from 1 to 1.7, from 1 to 1.6, from 1 to 1.5, from 1 to 1.4, from 1.01 to 4, from 1.02 to 4, from 1.03 to 4, from 1.04 to 4, from 1.05 to 4, from 1.1 to 4, from 1.2 to 4, from 1.3 to 4, from 1.4 to 4, from 1.5 to 4, from 1.75 to 4, from 1.01 to 3.75, from 1.02 to 3.5, from 1.03 to 3, from 1.04 to 2.75, from 1.05 to 2, or from 1.01 to 1.4).

In some examples, the difference between the first refractive index and the second refractive index can be 0.5 or more (e.g., 0.75 or more, 1 or more, 1.25 or more, 1.5 or more, 1.75 or more, 2 or more, 2.5 or more, or 3 or more).

The porous periodic nanolattice layer comprises a plurality of pores defined by a nanolattice formed of hollow members, the plurality of pores being periodic (e.g., arranged in an ordered array).

In some examples, the plurality of pores can have a periodicity of 1 nanometer (nm) or more (e.g., 2 nm or more, 3 nm or more, 4 nm or more, 5 nm or more, 6 nm or more, 7 nm or more, 8 nm or more, 9 nm or more, 10 nm or more, 15 nm or more, 20 nm or more, 25 nm or more, 30 nm or more, 35 nm or more, 40 nm or more, 45 nm or more, 50 nm or more, 60 nm or more, 70 nm or more, 80 nm or more, 90 nm or more, 100 nm or more, 125 nm or more, 150 nm or more, 175 nm or more, 200 nm or more, 225 nm or more, 250 nm or more, 275 nm or more, 300 nm or more, 350 nm or more, 400 nm or more, 450 nm or more, 500 nm or more, 550 nm or more, 600 nm or more, 650 nm or more, 700 nm or more, 750 nm or more, 800 nm or more, 850 nm or more, 900 nm or more, or 950 nm or more). In some examples, the plurality of pores can have a periodicity of 1 micrometer (μm) or less (e.g., 950 nm or less, 900 nm or less, 850 nm or less, 800 nm or less, 750 nm or less, 700 nm or less, 650 nm or less, 600 nm or less, 550 nm or less, 500 nm or less, 450 nm or less, 400 nm or less, 350 nm or less, 300 nm or less, 275 nm or less, 250 nm or less, 225 nm or less, 200 nm or less, 175 nm or less, 150 nm or less, 125 nm or less, 100 nm or less, 90 nm or less, 80 nm or less, 70 nm or less, 60 nm or less, 50 nm or less, 45 nm or less, 40 nm or less, 35 nm or less, 30 nm or less, 25 nm or less, 20 nm or less, 15 nm or less, 10 nm or less, 9 nm or less, 8 nm or less, 7 nm or less, 6 nm or less, 5 nm or less, 4 nm or less, 3 nm or less, or 2 nm or less). The periodicity of the plurality of pores can range from any of the minimum values described above to any of the maximum values described above. For example, the plurality of pores can have a periodicity of from 1 nanometer (nm) to 1 micrometer (μm) (e.g., from 1 nm to 500 nm, from 500 nm to 1000 nm, from 1 nm to 200 nm, from 200 nm to 400 nm, from 400 nm to 600 nm, from 600 nm to 800 nm, from 800 nm to 1000 nm, from 1 nm to 900 nm, from 1 nm to 800 nm, from 1 nm to 700 nm, from 1 nm to 600 nm, from 1 nm to 400 nm, from 1 nm to 300 nm, from 1 nm to 100 nm, from 5 nm to 1000 nm, from 10 nm to 1000 nm, from 15 nm to 1000 nm, from 20 nm to 1000 nm, from 25 nm to 1000 nm, from 30 nm to 1000 nm, from 40 nm to 1000 nm, from 50 nm to 1000 nm, from 75 nm to 1000 nm, from 100 nm to 1000 nm, from 200 nm to 1000 nm, from 300 nm to 1000 nm, from 400 nm to 1000 nm, from 600 nm to 1000 nm, from 700 nm to 1000 nm, from 5 nm to 950 nm, or from 10 nm to 900 nm).

The plurality of pores can have any shape, such as, for example, a polyhedron (e.g., a platonic solid, a prism, a pyramid), a cylinder, a hemicylinder, an elliptical cylinder, a hemi-elliptical cylinder, a cone, a semicone, etc.

The plurality of pores can have an average pore size. As used herein “pore size” refers to the largest cross-sectional dimension of a pore in a plane perpendicular to the longitudinal axis of the pore. For example, in the case of a substantially cylindrical pore, the pore size would be the diameter of the pore. In some examples, the average pore size can be substantially the same for the entire thickness of the layer. In some examples, the average pore size can vary with the thickness of the layer (e.g., tapered or conical pores). The average pore size can be determined, for example, using electron microscopy (e.g., scanning electron microscopy (SEM), scanning transmission electron microscopy (STEM)), Brunauer-Emmett-Teller (BET) measurements, porosimetry, or a combination thereof.

For example, the plurality of pores can have an average pore size of 10 nanometers (nm) or more (e.g., 15 nm or more, 20 nm or more, 25 nm or more, 30 nm or more, 35 nm or more, 40 nm or more, 45 nm or more, 50 nm or more, 60 nm or more, 70 nm or more, 80 nm or more, 90 nm or more, 100 nm or more, 125 nm or more, 150 nm or more, 175 nm or more, 200 nm or more, 225 nm or more, 250 nm or more, 275 nm or more, 300 nm or more, 350 nm or more, 400 nm or more, 450 nm or more, 500 nm or more, 550 nm or more, 600 nm or more, 650 nm or more, 700 nm or more, 750 nm or more, 800 nm or more, 850 nm or more, 900 nm or more, or 950 nm or more). In some examples, the plurality of pores can have an average pore size of 1 micrometer (μm) or less (e.g., 950 nm or less, 900 nm or less, 850 nm or less, 800 nm or less, 750 nm or less, 700 nm or less, 650 nm or less, 600 nm or less, 550 nm or less, 500 nm or less, 450 nm or less, 400 nm or less, 350 nm or less, 300 nm or less, 275 nm or less, 250 nm or less, 225 nm or less, 200 nm or less, 175 nm or less, 150 nm or less, 125 nm or less, 100 nm or less, 90 nm or less, 80 nm or less, 70 nm or less, 60 nm or less, 50 nm or less, 45 nm or less, 40 nm or less, 35 nm or less, 30 nm or less, 25 nm or less, 20 nm or less, or 15 nm or less). The average pore size of the plurality of pores can range from any of the minimum values described above to any of the maximum values described above. For example, the plurality of pores can have an average pore size of from 10 nanometers (nm) to 1 micrometer (μm) (e.g., from 10 nm to 500 nm, from 500 nm to 1000 nm, from 10 nm to 200 nm, from 200 nm to 400 nm, from 400 nm to 600 nm, from 600 nm to 800 nm, from 800 nm to 1000 nm, from 10 nm to 900 nm, from 10 nm to 800 nm, from 10 nm to 700 nm, from 10 nm to 600 nm, from 10 nm to 400 nm, from 10 nm to 300 nm, from 10 nm to 100 nm, from 15 nm to 1000 nm, from 20 nm to 1000 nm, from 25 nm to 1000 nm, from 30 nm to 1000 nm, from 40 nm to 1000 nm, from 50 nm to 1000 nm, from 75 nm to 1000 nm, from 100 nm to 1000 nm, from 200 nm to 1000 nm, from 300 nm to 1000 nm, from 400 nm to 1000 nm, from 600 nm to 1000 nm, from 700 nm to 1000 nm, from 15 nm to 950 nm, or from 20 nm to 900 nm).

In some examples, the plurality of pores can be substantially monodisperse. “Monodisperse” and “homogeneous size distribution,” as used herein, and generally describe a population of pores where all of the pores are the same or nearly the same size. As used herein, a monodisperse distribution refers to pore distributions in which 80% of the distribution (e.g., 85% of the distribution, 90% of the distribution, or 95% of the distribution) lies within 25% of the median pore size (e.g., within 20% of the median pore size, within 15% of the median pore size, within 10% of the median pore size, or within 5% of the median pore size).

The hollow members can, for example, comprise a wall defining an interior void space.

The walls of the hollow members can, in some examples, form a continuous phase. In some examples, the porous periodic nanolattice layer comprises two continuous void phases that are completely separated by a third continuous phase (e.g., the walls of the hollow members) that prevents any direct contact between the two continuous void phases.

The walls of the hollow members can, for example, have an average thickness of 1 nanometer (nm) or more (e.g., 2 nm or more, 3 nm or more, 4 nm or more, 5 nm or more, 6 nm or more, 7 nm or more, 8 nm or more, 9 nm or more, 10 nm or more, 15 nm or more, 20 nm or more, 25 nm or more, 30 nm or more, 35 nm or more, 40 nm or more, 45 nm or more, 50 nm or more, 55 nm or more, 60 nm or more, 65 nm or more, 70 nm or more, 75 nm or more, 80 nm or more, 85 nm or more, 90 nm or more, 95 nm or more, 100 nm or more, 110 nm or more, 120 nm or more, 130 nm or more, 140 nm or more, 150 nm or more, 175 nm or more, 200 nm or more, or 225 nm or more). In some examples, the walls of the hollow members can have an average thickness of 250 nm or less (e.g., 240 nm or less, 230 nm or less, 220 nm or less, 200 nm or less, 175 nm or less, 150 nm or less, 125 nm or less, 100 nm or less, 95 nm or less, 90 nm or less, 85 nm or less, 80 nm or less, 75 nm or less, 70 nm or less, 65 nm or less, 60 nm or less, 55 nm or less, 50 nm or less, 45 nm or less, 40 nm or less, 35 nm or less, 30 nm or less, 25 nm or less, 20 nm or less, 15 nm or less, 10 nm or less, 9 nm or less, 8 nm or less, 7 nm or less, 6 nm or less, 5 nm or less, 4 nm or less, 3 nm or less, or 2 nm or less). The average thickness of the walls of the hollow members can range from any of the minimum values described above to any of the maximum values described above. For example, the walls of the hollow members can have an average thickness of from 1 nanometer (nm) to 250 nm (e.g., from 1 nm to 125 nm, from 125 nm to 250 nm, from 1 nm to 50 nm, from 50 nm to 100 nm, from 100 nm to 150 nm, from 150 nm to 200 nm, from 200 nm to 250 nm, from 1 nm to 225 nm, from 1 nm to 200 nm, from 1 nm to 175 nm, from 1 nm to 150 nm, from 1 nm to 100 nm, from 1 nm to 75 nm, from 5 nm to 250 nm, from 10 nm to 250 nm, from 15 nm to 250 nm, from 20 nm to 250 nm, from 25 nm to 250 nm, from 30 nm to 250 nm, from 40 nm to 250 nm, from 50 nm to 250 nm, from 75 nm to 250 nm, from 100 nm to 250 nm, from 150 nm to 250 nm, from 5 nm to 225 nm, from 10 nm to 100 nm, or from 10 nm to 50 nm).

In some examples, the hollow members can be even-walled. By “even-walled” is meant that the thickness of the walls are substantially homogeneous or monodisperse, meaning that the distribution of the thickness of the walls in which 80% of the distribution (e.g., 85% of the distribution, 90% of the distribution, or 95% of the distribution) lies within 25% of the median wall thickness (e.g., within 20% of the median wall thickness, within 15% of the median wall thickness, within 10% of the median pore size, or within 5% of the median wall thickness).

The walls of the hollow members can comprise any suitable material. For example, the walls of the hollow members can comprise a dielectric material, a metal, or a combination thereof.

In some examples, the walls of the hollow members can comprise a metal chalcogenide (e.g. a compound comprising a metal and a chalcogen), a metal halide (e.g., a compound comprising a metal and a halogen), or a combination thereof. As used herein a “chalcogen” refers to any element from group 16, such as oxygen, sulfur, selenium, tellurium, and polonium. As such, metal chalcogenides can include metal oxides, metal sulfides, metal selenides, and metal tellurides, among others. The term “halide” or “halogen” or “halo” as used herein refers to fluorine, chlorine, bromine, and iodine.

In some examples, the walls of the hollow members can comprise a metal oxide. Examples of metal oxides include simple metal oxides (e.g., with a single metal element) and mixed metal oxides (e.g., with different metal elements). In some examples, the walls of the hollow members can comprise Al₂O₃, ZnO, SiO₂, TiO₂, or a combination thereof. In some examples, the walls of the hollow members can comprise Al₂O₃.

In some examples, the walls of the hollow members can further comprise a dopant (e.g., a first dopant). The dopant can comprise any suitable dopant for the wall material. The dopant can, for example, be selected to tune the optical, electronic, and/or thermal properties of the porous periodic nanolattice layer. In some examples, the concentration and/or identity of the dopant within the walls can vary, for example with thickness and/or radially.

The porous periodic nanolattice layer can, for example, have a porosity of 90% or more (e.g., 91% or more, 92% or more, 93% or more, 94% or more, 95% or more, 96% or more, 97% or more, 98% or more, or 99% or more). In some examples, the porosity of the porous periodic nanolattice layer can be selected in view of the desired refractive index of said layer (e.g., in view of the desired first refractive index).

In some examples, the porous periodic nanolattice layer has an average thickness of 1 nanometer (nm) or more (e.g., 2 nm or more, 3 nm or more, 4 nm or more, 5 nm or more, 6 nm or more, 7 nm or more, 8 nm or more, 9 nm or more, 10 nm or more, 15 nm or more, 20 nm or more, 25 nm or more, 30 nm or more, 35 nm or more, 40 nm or more, 45 nm or more, 50 nm or more, 60 nm or more, 70 nm or more, 80 nm or more, 90 nm or more, 100 nm or more, 125 nm or more, 150 nm or more, 175 nm or more, 200 nm or more, 225 nm or more, 250 nm or more, 275 nm or more, 300 nm or more, 350 nm or more, 400 nm or more, 450 nm or more, 500 nm or more, 550 nm or more, 600 nm or more, 650 nm or more, 700 nm or more, 750 nm or more, 800 nm or more, 850 nm or more, 900 nm or more, or 950 nm or more). In some examples, the porous periodic nanolattice layer has an average thickness of 1 micrometer (μm) or less (e.g., 950 nm or less, 900 nm or less, 850 nm or less, 800 nm or less, 750 nm or less, 700 nm or less, 650 nm or less, 600 nm or less, 550 nm or less, 500 nm or less, 450 nm or less, 400 nm or less, 350 nm or less, 300 nm or less, 275 nm or less, 250 nm or less, 225 nm or less, 200 nm or less, 175 nm or less, 150 nm or less, 125 nm or less, 100 nm or less, 90 nm or less, 80 nm or less, 70 nm or less, 60 nm or less, 50 nm or less, 45 nm or less, 40 nm or less, 35 nm or less, 30 nm or less, 25 nm or less, 20 nm or less, 15 nm or less, 10 nm or less, 9 nm or less, 8 nm or less, 7 nm or less, 6 nm or less, or 5 nm or less). The average thickness of the porous periodic nanolattice layer can range from any of the minimum values described above to any of the maximum values described above. For example, the porous periodic nanolattice layer can have an average thickness of from 1 nanometer (nm) to 1 micrometer (μm) (e.g., from 1 nm to 500 nm, from 500 nm to 1000 nm, from 1 nm to 200 nm, from 200 nm to 400 nm, from 400 nm to 600 nm, from 600 nm to 800 nm, from 800 nm to 1000 nm, from 1 nm to 900 nm, from 1 nm to 800 nm, from 1 nm to 700 nm, from 1 nm to 600 nm, from 1 nm to 400 nm, from 1 nm to 300 nm, from 1 nm to 100 nm, from 5 nm to 1000 nm, from 10 nm to 1000 nm, from 15 nm to 1000 nm, from 20 nm to 1000 nm, from 25 nm to 1000 nm, from 30 nm to 1000 nm, from 40 nm to 1000 nm, from 50 nm to 1000 nm, from 75 nm to 1000 nm, from 100 nm to 1000 nm, from 200 nm to 1000 μm, from 300 nm to 1000 nm, from 400 nm to 1000 nm, from 600 nm to 1000 nm, from 700 nm to 1000 nm, from 5 nm to 950 nm, from 10 nm to 900 nm, from 100 nm to 500 nm, from 100 nm to 250 nm, or from 100 nm to 150 nm).

In some examples, the average thickness of the porous periodic nanolattice layer, the average thickness of the walls of the hollow members, the composition of the walls of the hollow members, the average pore size, the periodicity of the plurality of pores, the porosity of the porous periodic nanolattice layer, the presence of the dopant, the concentration of the dopant, the distribution of the dopant, or a combination thereof can be selected such that the porous periodic nanolattice layer has a desired mechanical property (e.g., mechanical stiffness), optical property (e.g., refractive index), electrical property, thermal property, or combination thereof.

The porous periodic nanolattice layer can, for example, have a mechanical stiffness sufficient to support the continuous layer.

The continuous layer can comprise any suitable material. For example, the continuous layer can comprise a dielectric material, a metal, or a combination thereof.

In some examples, the continuous layer can comprise a metal chalcogenide (e.g. a compound comprising a metal and a chalcogen), a metal halide (e.g., a compound comprising a metal and a halogen), or a combination thereof. In some examples, the continuous layer can comprise a metal oxide. Examples of metal oxides include simple metal oxides (e.g., with a single metal element) and mixed metal oxides (e.g., with different metal elements). In some examples, the continuous layer comprises TiO₂, Al₂O₃, ZnO, or a combination thereof.

In some examples, the continuous layer can further comprise a dopant (e.g., a second dopant). The dopant can comprise any suitable dopant for the continuous layer material. The dopant can, for example, be selected to tune the optical, electronic, and/or thermal properties of the continuous layer. In some examples, the concentration and/or identity of the dopant within the continuous layer can vary, for example with thickness and/or lateral dimension (e.g., concentration gradient with thickness).

The continuous layer can, for example, have an average thickness of 1 nanometer (nm) or more (e.g., 2 nm or more, 3 nm or more, 4 nm or more, 5 nm or more, 6 nm or more, 7 nm or more, 8 nm or more, 9 nm or more, 10 nm or more, 15 nm or more, 20 nm or more, 25 nm or more, 30 nm or more, 35 nm or more, 40 nm or more, 45 nm or more, 50 nm or more, 60 nm or more, 70 nm or more, 80 nm or more, 90 nm or more, 100 nm or more, 125 nm or more, 150 nm or more, 175 nm or more, 200 nm or more, 225 nm or more, 250 nm or more, 275 nm or more, 300 nm or more, 350 nm or more, 400 nm or more, 450 nm or more, 500 nm or more, 550 nm or more, 600 nm or more, 650 nm or more, 700 nm or more, 750 nm or more, 800 nm or more, 850 nm or more, 900 nm or more, or 950 nm or more). In some examples, the continuous layer has an average thickness of 1 micrometer (μm) or less (e.g., 950 nm or less, 900 nm or less, 850 nm or less, 800 nm or less, 750 nm or less, 700 nm or less, 650 nm or less, 600 nm or less, 550 nm or less, 500 nm or less, 450 nm or less, 400 nm or less, 350 nm or less, 300 nm or less, 275 nm or less, 250 nm or less, 225 nm or less, 200 nm or less, 175 nm or less, 150 nm or less, 125 nm or less, 100 nm or less, 90 nm or less, 80 nm or less, 70 nm or less, 60 nm or less, 50 nm or less, 45 nm or less, 40 nm or less, 35 nm or less, 30 nm or less, 25 nm or less, 20 nm or less, 15 nm or less, 10 nm or less, 9 nm or less, 8 nm or less, 7 nm or less, 6 nm or less, or 5 nm or less). The average thickness of the continuous layer can range from any of the minimum values described above to any of the maximum values described above. For example, the continuous layer can have an average thickness of from 1 nanometer (nm) to 1 micrometer (μm) (e.g., from 1 nm to 500 nm, from 500 nm to 1000 nm, from 1 nm to 200 nm, from 200 nm to 400 nm, from 400 nm to 600 nm, from 600 nm to 800 nm, from 800 nm to 1000 nm, from 1 nm to 900 nm, from 1 nm to 800 nm, from 1 nm to 700 nm, from 1 nm to 600 nm, from 1 nm to 400 nm, from 1 nm to 300 nm, from 1 nm to 100 nm, from 5 nm to 1000 nm, from 10 nm to 1000 nm, from 15 nm to 1000 nm, from 20 nm to 1000 nm, from 25 nm to 1000 nm, from 30 nm to 1000 nm, from 40 nm to 1000 nm, from 50 nm to 1000 nm, from 75 nm to 1000 nm, from 100 nm to 1000 nm, from 200 nm to 1000 nm, from 300 nm to 1000 nm, from 400 nm to 1000 nm, from 600 nm to 1000 nm, from 700 nm to 1000 nm, from 5 nm to 950 nm, from 10 nm to 900 nm, from 10 nm to 500 nm, from 50 nm to 250 nm, or from 50 nm to 100 nm).

In some examples, the average thickness of the continuous layer, the composition of the continuous layer, the presence of the dopant, the concentration of the dopant, the distribution of the dopant, or a combination thereof can be selected such that the continuous layer has a desired mechanical property (e.g., mechanical stiffness), optical property (e.g., refractive index), electrical property, thermal property, or combination thereof.

The continuous layer can, for example, have a mechanical stiffness sufficient to support the porous periodic nanolattice layer.

In some examples, the composite materials can further comprise a substrate. In some examples, the porous periodic nanolattice layer is disposed on the substrate, such that the porous periodic nanolattice layer is sandwiched between the substrate and the continuous layer. In some examples, the continuous layer is disposed on the substrate, such that the continuous layer is sandwiched between the substrate and the porous periodic nanolattice layer.

The substrate can comprise an suitable material. For example, the substrate can comprise a dielectric, a semiconductor, a ceramic, a transparent conducing oxide, a polymer, a metal, or a combination thereof. In some examples, the substrate can be transparent. As used herein, a “transparent substrate” is meant to include any substrate that is transparent at the wavelength or wavelength region of interest. Examples of substrates include, but are not limited to, silicon, group III-V semiconductors, glass, quartz, parylene, silicon dioxide, sapphire, mica, poly(methyl methacrylate), polyamide, polycarbonate, polyester, polypropylene, polytetrafluoroethvlene, polydimethylsiloxane (PDMS), hafnium oxide, hafnium silicate, tantalum pentoxide, zirconium dioxide, zirconium silicate, and combinations thereof.

In some examples, the composite materials can further comprise one or more additional layers. In some examples, one or more additional layers are disposed on the porous periodic nanolattice layer, such that that the porous periodic nanolattice layer is sandwiched between the continuous layer and the one or more additional layers. In some examples, one or more additional layers disposed on the continuous layer, such that the continuous layer is sandwiched between the porous periodic nanolattice layer and the one or more additional layers. In some examples, the continuous layer and/or the porous periodic nanolattice layer independently have a mechanical stiffness sufficient to support the one or more additional layers.

In some examples, each of the one or more additional layers comprises a material having a refractive index, and the refractive index of a given layer is different than the refractive index of the preceding layer and/or subsequent layer. Each of the one or more additional layers can independently comprise any suitable material, including, but not limited to, dielectric materials, semiconductors, ceramics, transparent conducing oxides, phase change materials, polymers, metals, and combinations thereof.

Each of the one or more additional layers independently has an average thickness of 1 nanometer (nm) or more (e.g., 2 nm or more, 3 nm or more, 4 nm or more, 5 nm or more, 6 nm or more, 7 nm or more, 8 nm or more, 9 nm or more, 10 nm or more, 15 nm or more, 20 nm or more, 25 nm or more, 30 nm or more, 35 nm or more, 40 nm or more, 45 nm or more, 50 nm or more, 60 nm or more, 70 nm or more, 80 nm or more, 90 nm or more, 100 nm or more, 125 nm or more, 150 nm or more, 175 nm or more, 200 nm or more, 225 nm or more, 250 nm or more, 275 nm or more, 300 nm or more, 350 nm or more, 400 nm or more, 450 nm or more, 500 nm or more, 550 nm or more, 600 nm or more, 650 nm or more, 700 nm or more, 750 nm or more, 800 nm or more, 850 nm or more, 900 nm or more, or 950 nm or more). In some examples, each of the one or more additional layers independently can have an average thickness of 1 micrometer (μm) or less (e.g., 950 nm or less, 900 nm or less, 850 nm or less, 800 nm or less, 750 nm or less, 700 nm or less, 650 nm or less, 600 nm or less, 550 nm or less, 500 nm or less, 450 nm or less, 400 nm or less, 350 nm or less, 300 nm or less, 275 nm or less, 250 nm or less, 225 nm or less, 200 nm or less, 175 nm or less, 150 nm or less, 125 nm or less, 100 nm or less, 90 nm or less, 80 nm or less, 70 nm or less, 60 nm or less, 50 nm or less, 45 nm or less, 40 nm or less, 35 nm or less, 30 nm or less, 25 nm or less, 20 nm or less, 15 nm or less, 10 nm or less, 9 nm or less, 8 nm or less, 7 nm or less, 6 nm or less, or 5 nm or less). The average thickness of each of the one or more additional layers can independently range from any of the minimum values described above to any of the maximum values described above. For example, each of the one or more additional layers can independently have an average thickness of from 1 nanometer (nm) to 1 micrometer (μm) (e.g., from 1 nm to 500 nm, from 500 nm to 1000 nm, from 1 nm to 200 nm, from 200 nm to 400 nm, from 400 nm to 600 nm, from 600 nm to 800 nm, from 800 nm to 1000 nm, from 1 nm to 900 nm, from 1 nm to 800 nm, from 1 nm to 700 nm, from 1 nm to 600 nm, from 1 nm to 400 nm, from 1 nm to 300 nm, from 1 nm to 100 nm, from 5 nm to 1000 nm, from 10 nm to 1000 nm, from 15 nm to 1000 nm, from 20 nm to 1000 nm, from 25 nm to 1000 nm, from 30 nm to 1000 nm, from 40 nm to 1000 nm, from 50 nm to 1000 nm, from 75 nm to 1000 nm, from 100 nm to 1000 nm, from 200 nm to 1000 nm, from 300 nm to 1000 nm, from 400 nm to 1000 nm, from 600 nm to 1000 nm, from 700 nm to 1000 nm, from 5 nm to 950 nm, from 10 nm to 900 nm, or from 100 nm to 500 nm).

In some examples, wherein the composite material comprises a stack comprising a plurality of alternating layers of the porous periodic nanolattice layer and the continuous layer.

The total number of layers in the composite material can, for example, be 2 or more (e.g., 3 or more, 4 or more, 5 or more, 6 or more, 7 or more, 8 or more, 9 or more, 10 or more, 15 or more, 20 or more, 25 or more, 30 or more, 35 or more, 40 or more, 45 or more, 50 or more, 55 or more, 60 or more, 65 or more, 70 or more, 75 or more, 80 or more, 85 or more, 90 or more, or 95 or more). In some examples, the total number of layer in the composite material can be 100 or less (e.g., 95 or less, 90 or less, 85 or less, 80 or less, 75 or less, 70 or less, 65 or less, 60 or less, 55 or less, 50 or less, 45 or less, 40 or less, 35 or less, 30 or less, 25 or less, 20 or less, 15 or less, 10 or less, 9 or less, 8 or less, 7 or less, 6 or less, 5 or less, 4 or less, or 3 or less). The total number of layers in the composite material can range from any of the minimum values described above to any of the maximum values described above. For example, the total number of layers in the composite material can be from 2 to 100 (e.g., from 2 to 50, from 50 to 100, from 2 to 20, from 20 to 40, from 40 to 60, from 60 to 80, from 80 to 100, from 2 to 95, from 2 to 90, from 2 to 80, from 2 to 70, from 2 to 60, from 2 to 40, from 2 to 10, from 3 to 100, from 4 to 100, from 5 to 100, from 6 to 100, from 7 to 100, from 8 to 100, from 9 to 100, from 10 to 100, from 15 to 100, from 20 to 100, from 25 to 100, from 30 to 100, from 40 to 100, from 60 to 100, from 70 to 100, from 3 to 95, from 4 to 90, or from 5 to 85).

In some examples, the composite material comprises a Bragg reflector.

In some examples, the composite material comprises a one-dimensional photonic crystal.

In some examples, the composite material reflects one or more wavelengths of the solar spectrum with a reflectivity of 80% or more (e.g., 85% or more, 90% or more, 95% or more, or 99% or more). In some examples, the composite material has an average specular reflectance of 80% or more (e.g., 85% or more, 90% or more, 95% or more, or 99% or more) over at least a portion of the solar spectrum.

In some examples, the composite material has a reflectance peak and the FWHM (full width at half maximum) of the reflectance peak is 300 nm or more (e.g., 325 nm or more, 350 nm or more, 375 nm or more, 400 nm or more, 425 nm or more, 450 nm or more, 475 nm or more, 500 nm or more, 550 nm or more, 600 nm or more, 650 nm or more, 700 nm or more, or 750 nm or more).

In some examples, the composite material is a low k dielectric.

In some examples, the composite material has a low thermal conductivity.

In some examples, the composite material has a low refractive index.

In some examples, the composite material has a low stiffness.

### Methods of Making

Also disclosed herein are methods of making any of the composite materials disclosed herein.

Also disclosed herein are methods of making a composite material, the method comprising: (a) forming a patterned layer; (b) depositing a first material on the patterned layer, thereby forming a coated patterned layer; (c) depositing a buffer material layer on the coated patterned layer, thereby forming a planarized layer; (d) depositing a continuous layer on the planarized layer; and (e) removing the buffer material layer and the patterned layer, thereby forming the composite material. The composite material can, for example, comprise: a porous periodic nanolattice layer; and a continuous layer; wherein the continuous layer is disposed on the porous periodic nanolattice layer; wherein the porous periodic nanolattice layer has a first refractive index and the continuous layer has a second refractive index; wherein the first refractive index and the second refractive index are different; and wherein the porous periodic nanolattice layer comprises a plurality of pores defined by a nanolattice formed of hollow members, the plurality of pores being periodic (e.g., arranged in an ordered array). For example, the composite material made by these methods can comprise any of the composite materials described herein.

In some examples, the methods can further comprise repeating steps (a) to (d) one or more times before performing removing step (e).

In some examples, the methods can further comprise depositing one or more additional layers before performing removing step (e).

Forming the patterned layer can, for example, comprise 3D nanolithography, nanosphere lithography, phase-shift lithography, holographic lithography, an additive manufacturing process, an imprint process, a self-assembly process, or a combination thereof. In some examples, forming the patterned photoresist layer comprises nanosphere lithography, near-field phase-shift lithography, or a combination thereof.

In some examples, forming the patterned layer comprises: depositing a photoresist layer; forming a monolayer of nanospheres on the photoresist layer; irradiating the monolayer of nanospheres with light configured to pattern the photoresist layer; and removing the nanospheres.

The photoresist layer can, for example, be deposited using spin coating, drop-casting, zone casting, dip coating, blade coating, spraying, vacuum filtration, or combinations thereof. In some examples, the photoresist layer is deposited on a substrate. In some examples, the substrate further comprises an antireflection layer and the method comprises depositing the photoresist layer on the antireflection layer.

The nanospheres can comprise any suitable material. For example, the nanospheres can comprise a polymer (e.g., polystyrene), a dielectric material (e.g., silica), a metal oxide, a metal, or a combination thereof.

In some examples, the nanospheres can have an average diameter of 1 nanometer (nm) or more (e.g., 2 nm or more, 3 nm or more, 4 nm or more, 5 nm or more, 6 nm or more, 7 nm or more, 8 nm or more, 9 nm or more, 10 nm or more, 15 nm or more, 20 nm or more, 25 nm or more, 30 nm or more, 35 nm or more, 40 nm or more, 45 nm or more, 50 nm or more, 60 nm or more, 70 nm or more, 80 nm or more, 90 nm or more, 100 nm or more, 125 nm or more, 150 nm or more, 175 nm or more, 200 nm or more, 225 nm or more, 250 nm or more, 275 nm or more, 300 nm or more, 350 nm or more, 400 nm or more, 450 nm or more, 500 nm or more, 550 nm or more, 600 nm or more, 650 nm or more, 700 nm or more, 750 nm or more, 800 nm or more, 850 nm or more, 900 nm or more, or 950 nm or more). In some examples, the nanospheres can have an average diameter of 1 micrometer (μm) or less (e.g., 950 nm or less, 900 nm or less, 850 nm or less, 800 nm or less, 750 nm or less, 700 nm or less, 650 nm or less, 600 nm or less, 550 nm or less, 500 nm or less, 450 nm or less, 400 nm or less, 350 nm or less, 300 nm or less, 275 nm or less, 250 nm or less, 225 nm or less, 200 nm or less, 175 nm or less, 150 nm or less, 125 nm or less, 100 nm or less, 90 nm or less, 80 nm or less, 70 nm or less, 60 nm or less, 50 nm or less, 45 nm or less, 40 nm or less, 35 nm or less, 30 nm or less, 25 nm or less, 20 nm or less, 15 nm or less, 10 nm or less, 9 nm or less, 8 nm or less, 7 nm or less, 6 nm or less, 5 nm or less, 4 nm or less, 3 nm or less, or 2 nm or less). The average diameter of the nanospheres can range from any of the minimum values described above to any of the maximum values described above. For example, the nanospheres can have an average diameter of from 1 nanometer (nm) to 1 micrometer (μm) (e.g., from 1 nm to 500 nm, from 500 nm to 1000 nm, from 1 nm to 200 nm, from 200 nm to 400 nm, from 400 nm to 600 nm, from 600 nm to 800 nm, from 800 nm to 1000 nm, from 1 nm to 900 nm, from 1 nm to 800 nm, from 1 nm to 700 nm, from 1 nm to 600 nm, from 1 nm to 400 nm, from 1 nm to 300 nm, from 1 nm to 100 nm, from 5 nm to 1000 nm, from 10 nm to 1000 nm, from 15 nm to 1000 nm, from 20 nm to 1000 nm, from 25 nm to 1000 nm, from 30 nm to 1000 nm, from 40 nm to 1000 nm, from 50 nm to 1000 nm, from 75 nm to 1000 nm, from 100 nm to 1000 nm, from 200 nm to 1000 nm, from 300 nm to 1000 nm, from 400 nm to 1000 nm, from 600 nm to 1000 nm, from 700 nm to 1000 nm, from 5 nm to 950 nm, from 10 nm to 900 nm, from 100 nm to 1 μm, from 100 nm to 750 nm, or from 300 nm to 500 nm). In some examples, the nanospheres can be substantially monodisperse. The average diameter of the nanospheres can be selected, for example, to control the average pore size and/or periodicity of the plurality of pores of the porous periodic nanolattice layer.

The monolayer of nanospheres can be formed, for example, via self-assembly, Langmuir-Blodgett deposition, dip coating, spin coating, solvent evaporation, force-assembly methods, air-water interface methods, drop-casting, zone casting, blade coating, or a combination thereof.

In some examples, the monolayer of nanospheres are irradiated with UV light. In some examples, the monolayer of nanospheres are irradiated with a suitable dose for the photoresist.

The first material can, for example, be deposited using electroplating, lithographic deposition, electron beam deposition, thermal deposition, chemical vapor deposition (CVD), atomic layer deposition (ALD), physical vapor deposition (PVD), sputtering, pulsed layer deposition, molecular beam epitaxy, evaporation, or combinations thereof. In some examples, the first material is deposited using atomic layer deposition (ALD).

The first material can comprise any suitable material. The first material forms the walls of the hollow members.

The buffer material layer can, for example, be deposited using spin coating, drop-casting, zone casting, dip coating, blade coating, spraying, vacuum filtration, or combinations thereof. The buffer material can comprise any suitable material, such as a second photoresist material.

The continuous layer can, for example, be deposited using electroplating, lithographic deposition, electron beam deposition, thermal deposition, chemical vapor deposition (CVD), atomic layer deposition (ALD), physical vapor deposition (PVD), sputtering, pulsed layer deposition, molecular beam epitaxy, evaporation, or combinations thereof. In some examples, the continuous layer is deposited using atomic layer deposition (ALD).

In some examples, the removing step comprises a thermal cycle, plasma etching, wet etching, solvent removal, or a combination thereof. The removal step can be performed, for example, in a manner that minimizes or avoids collapse and/or distortion of the composite materials.

### Methods of Use

Also disclosed herein are methods of use of any of the composite materials disclosed herein. For example, the methods can comprise using the composite material in an optical device, an electronic device, or an optoelectronic device. In some examples, the methods can comprise using the composite material in a photonic application, an electronic application, a thermal application, or a combination thereof. In some examples, the method comprises using the composite material as a photonic crystal, as a dielectric mirror, for thermal isolation, for selective reflection, or a combination thereof. In some examples, the method comprises using the composite material as a Bragg reflector, an electric insulator, a thermal insulator, or a combination thereof. In some examples, the method comprises using the composite material as a porous filter. In some examples, the method comprises using the composite material as a mechanical damping system. In some examples, the methods can comprise using the composite material in a mechanical device, an energy dissipation device, an energy storage device, a spring system, or a combination thereof. In some examples, the methods can comprise using the composite material in a filter device.

### Devices

Also disclosed herein are devices and/or articles of manufacture comprising any of the composite materials disclosed herein. For example, the article and/or device can comprise an optical device, an electronic device, or an optoelectronic device. In some examples, the article and/or device comprises a photonic crystal, a dielectric mirror, a Bragg reflector, or a combination thereof. In some examples, the article and/or device comprises a porous filter. In some examples, the article and/or device comprises a mechanical damping system.

In some examples, the article and/or device can comprise a mechanical device, an energy dissipation device, an energy storage device, a spring system, or a combination thereof. In some examples, the article and/or device can comprise a filter device.

A number of embodiments of the invention have been described. Nevertheless, it will be understood that various modifications may be made without departing from the spirit and scope of the invention. Accordingly, other embodiments are within the scope of the following claims.

The examples below are intended to further illustrate certain aspects of the systems and methods described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of measurement conditions, e.g., component concentrations, temperatures, pressures and other measurement ranges and conditions that can be used to optimize the described process.

### Example 1—Nanolattice Dielectric Mirror with Selective Reflectance Band

Cooling strategies have been an important energy topic for decades. As global warning becomes more and more evident, active cooling methods consume significant amounts of energy and have become one of the biggest electricity demands. The U.S. Department of Energy estimates that air conditioning systems use nearly one-sixth of the primary energy consumed by a building in the United States. As a result, reliable passive cooling approaches that can cool a system without energy consumption are attracting more and more attention.

Among various passive cooling methods, radiation cooling (which has the advantage of all day cooling) has become one of the most popular topics in the recent years (Raman et al. Nature, 2014, 515, 40-44; Lim, Nature, 2019, 577, 18-20; Pech-May et al. Nanoscale Adv. 2020, 2, 249-255). Radiation cooling technology maintains a device temperature below that of the ambient air by radiating heat to outer space through the Earth's atmosphere's transparency window, which is roughly between wavelengths of 8 to 13 μm. Because the device would receive the radiation heat from the sun during daytime, a radiation cooler should also exhibit good reflectance for the solar spectrum. Accordingly, a dielectric mirror comprising a 1D photonic crystal is a good candidate for radiation cooling, as the dispersion behavior is flexible bases on the bandgap design of the periodic stack of the photonic crystal. Herein, the design and optical characterization of a dielectric mirror for radiation cooling is discussed.

Design of a Nanolattice Photonic Crystal Reflector. Passive cooling during the night is spontaneous as the radiation wavelength of an object at room temperature (293 K) is about 9.9 μm, which is in the transparent window of the atmosphere (8 to 13 μm). This means that an object can radiate thermal energy to outer space. However, the thermal energy transmission from the environment will increase corresponding to the increasing of the temperature difference between the device and the environment. Therefore, the cooling power of a passive cooler at night under steady state is given by (Raman et al. Nature, 2014, 515, 40-44):

$${P}_{c} ( T ) = {P}_{rad} ( T ) - {P}_{air rad} ( {T}_{amb} ) - {P}_{cond} - {P}_{conv}$$

Here P_{rad}(T) is the radiation from the device to outer space, P_{air rad}(T_{amb}) is the radiation from the ambient air to the device, P_{cond} and P_{conv} are the thermal conduction and convection from the environment, respectively.

However, as the passive cooler is exposed to solar radiation during the day, it obtains additional thermal energy from the solar radiation such that the total cooling power becomes:

$${P}_{c} ( T ) = {P}_{rad} ( T ) - {P}_{sun} - {P}_{air rad} ( {T}_{amb} ) - {P}_{cond} - {P}_{conv}$$

where Pₛᵤₙ is the solar irradiance. In the case of black body radiation, Pₛᵤₙ is much larger than P_{rad}(T) such that passive cooling does not work for most materials during the day. However, the solar radiation to a system can be significantly reduced if the cooler surface is highly reflective in the solar spectrum to overcome Pₛᵤₙ.

Dielectric mirrors are good candidates for achieving high reflectivity in the solar spectrum and high transparency in the atmosphere's transparent window because the reflectivity of dielectric mirrors can be adjusted by using different material pairings for the alternating optical materials while maintaining high emissivity in the infrared. The bandgap frequency bandwidth of a 1D photonic crystal is proportional to the refractive index contrast between the alternating materials, which can be calculated by (Fink et al. Science 1998, 282, 1679-1682):

$$\frac{Δ f}{{f}_{0}} = \frac{4}{π} asin ( \frac{{n}_{2} - {n}_{1}}{{n}_{2} + {n}_{1}} )$$

Here Δf is the bandwidth of the stopband, f₀ is the central frequency of the bandgap, n₁ and n₂ are the refractive index of alternating materials, respectively. Because most of the solar irradiance is in the range of 250 nm to 2.5 μm, multiple dielectric mirrors with a range of periods are needed to cover the full spectrum.

Herein, a nanolattice layer made with nanostructures having a 500 nm period coated with 10 nm Al₂O₃(ALD thin film) (n˜1.1) and a TiO₂ film (n˜2.3) made by e-beam evaporation were employed as the low-index and high-index material, respectively. As a result, the calculated Δf/f₀ of the nanolattice-TiO₂ pair is about 0.46.

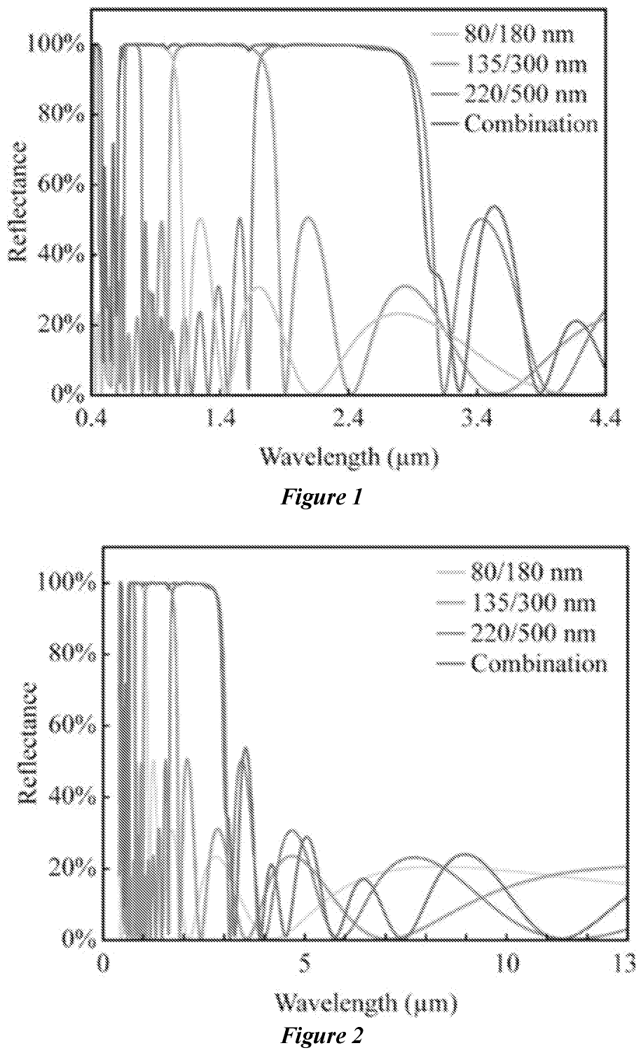

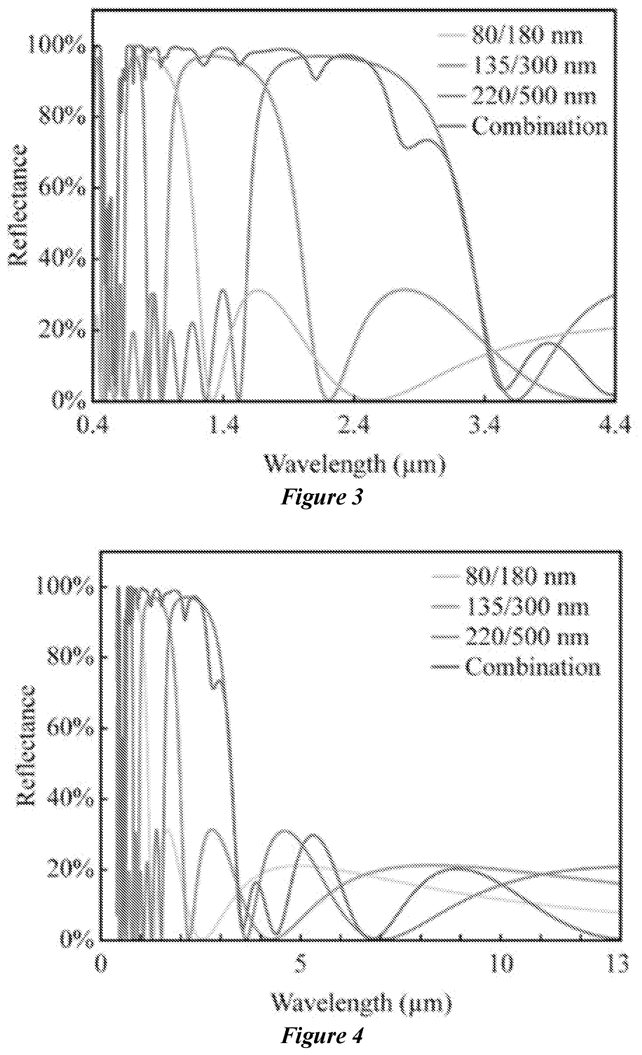

In this work, three reflectors with the nanolattice/TiO₂ pairs of varying thicknesses were used, specifically having thickness pairs of 180 nm/80 nm, 300 nm/135 nm, and 500 nm/220 nm. Rigorous coupled-wave analysis (RCWA) was used to simulate the resulting reflection of the dielectric mirrors with different number of repeating pairs of the low/high refractive index materials, as shown in FIG. 1-FIG. 4. FIG. 1 demonstrates the reflectance of the dielectric mirror in the range of 400 nm to 3.4 μm. Reflectors having 5 pairs of nanolattice/TiO₂ repeating units with the 180/80, 300/135, and 500/220 nm thicknesses were simulated. Further, a “combination stack” reflector was also simulated, which includes each of the 180/80, 300/135, and 500/220 nm nanolattice/TiO₂ pairs (1 repeating unit total). The mirrors with a single period (e.g., 5 pairs of nanolattice/TiO₂ repeating units with the 180/80, 300/135, and 500/220 nm thicknesses) have a central frequency of 835, 1400, and 2315 nm with a bandwidth of 430, 740, and 1230 nm, respectively (FIG. 1). The reflectance of the dielectric mirrors in the wavelength range from 0 up to 13 μm are shown in FIG. 2. The results demonstrate that the sum of emissivity and transmission of all the reflectors are higher than 80% in the atmospheric transparent window. Note the emissivity is equal to the absorptivity at thermal equilibrium, which is equal to 1-R-T. FIG. 3 and FIG. 4 show the results of the mirrors with 3 pairs of the repeating unit. The comparisons between FIG. 1 and FIG. 3, FIG. 2 and FIG. 4 illustrate that as the number of repeats of the low/high index material is lowered, the stopband phenomenon becomes less significant as well. However, the results from the mirrors with only three repeating units still meet the dispersion behavior needed for the desired reflection/transmission zone.

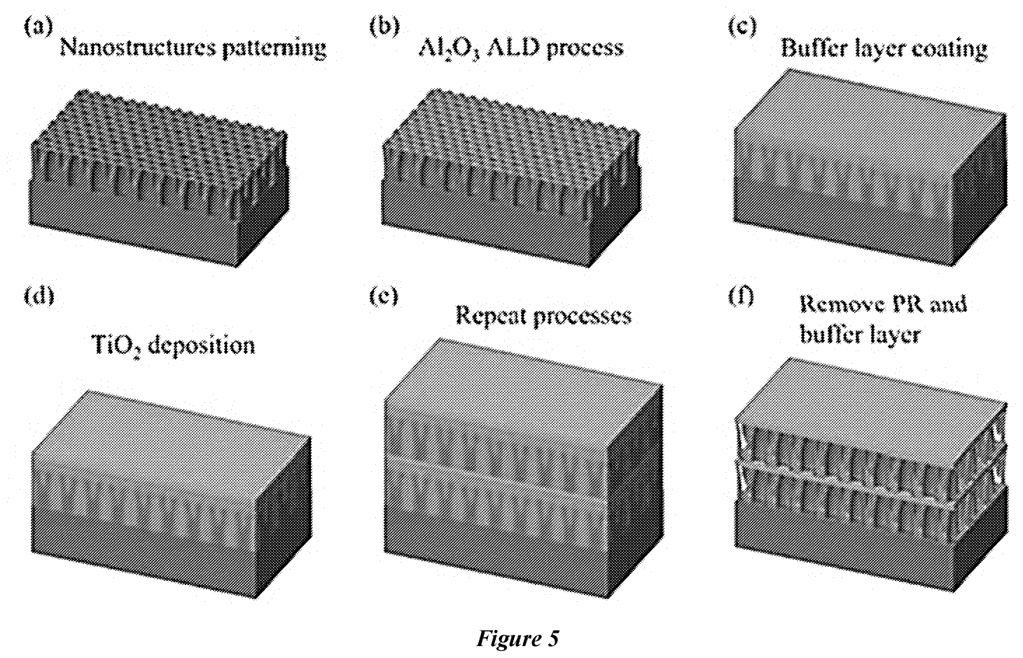

Fabrication of the nanolattice photonic crystal reflectors. The fabrication process for the nanolattice photonic crystal dielectric mirrors are illustrated in the FIG. 5. The nanostructures are first patterned using 3D phase lithography using colloidal particles as shown in panel (a) of FIG. 5. The nanostructures are employed as the template for the ALD process to build a conformal film on the surface of the nanostructures, as demonstrated in panel (b) of FIG. 5. Net, as shown in panel (c) of FIG. 5, a photoresist buffer layer coating process is applied to cover the underlying nanolattice, thereby planarizing the structures. A continuous TiO₂ film is then deposited by an e-beam evaporation process to build the high-index layer in the dielectric mirror, as shown in panel (d) of FIG. 5. By repeating the process shown in panels (a) to (d) of FIG. 5, multiple layers of the nanolattice-TiO₂ stack can be fabricated as shown in panel (e) of FIG. 5. A thermal cycle or plasma etching process can then be used to remove the photoresist and buffer layer materials to form low-index and freestanding nanolattice layers between the high-index TiO₂ films, resulting in a high contrast photonic crystal dielectric mirror as shown in panel (f) of FIG. 5. The thickness of the low-index nanolattice layer can be controlled by the thickness of the photoresist used for the nanostructure patterning, and the thickness of the high-index TiO₂ films can be controlled by the evaporation deposition process. Herein, reflectors with three different repeating periods were examined and fabricated. Based on the rigorous coupled-wave analysis simulation, dielectric reflectors with nanolattice/TiO₂ thickness ratios of 180 nm/80 nm, 300 nm/135 nm, and 500 nm/220 nm were fabricated to build a broadband reflector which is able to cover the solar spectrum.

The rigorous coupled-wave analysis result shown in the FIG. 3 and FIG. 4 illustrate that the nanolattice photonic crystal mirror with three pairs of the repeating unit is able to achieve adequate broadband reflectance. As the result, dielectric mirrors with 3 pairs of 180 nm/80 nm, 300 nm/135 nm, and 500 nm/220 nm nanolattice/TiO₂ alternating stacks were fabricated to characterize their optical properties.

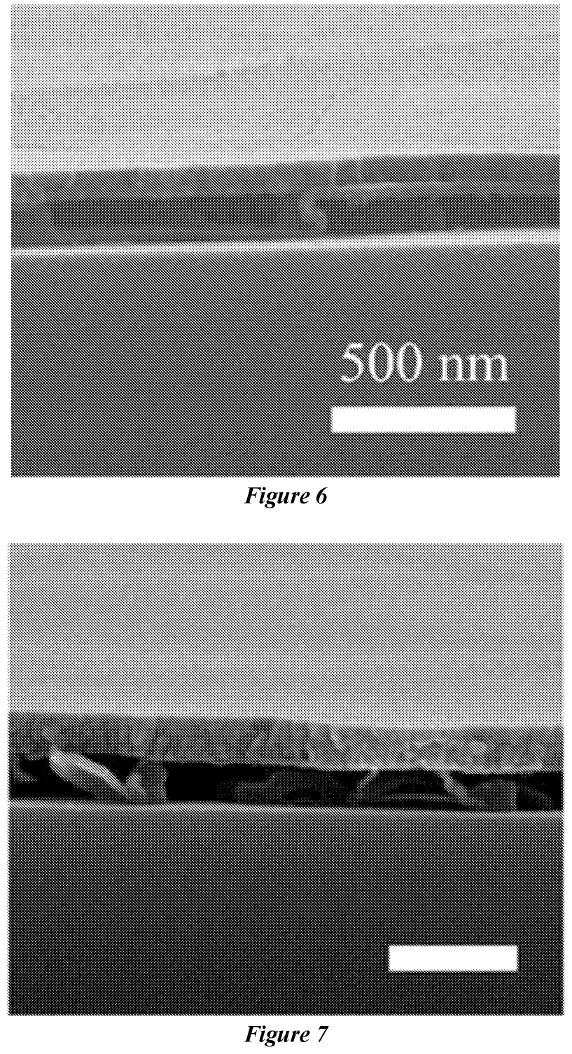

In these experiments, silicon wafers (100-mm single-side polished Si wafer, University Wafer) coated with a 100 nm-thick antireflection layer (ARC i-con-16, Brewer Science) were used as a substrate. Hexagonal-close-packed 500 nm diameter polystyrene nanospheres self-assembly were employed as periodic phase elements for the near-field phase-shift lithography process to pattern periodic nanostructures in the photoresist (PFi-88A2, Sumitomo). PGMEA (>99.5% Propylene glycol monomethyl ether acetate, Sigma Aldrich) was used to dilute the photoresist for reaching the desired thickness. A 11.5 nm thick Al₂O₃ film was deposited onto the nanostructures by a commercial ALD system (ALD™ 200, Cambridge NanoTech Inc.). An additional layer of photoresist was spin-coated onto the ALD covered nanostructures and performs as a buffer layer. An e-beam evaporation process (PVD75 e-beam and sputtering system, Kurt J. Lesker) was then applied to deposit the TiO₂ layer with corresponding thickness on the buffer layer. The lithography, ALD, planarization, and e-beam evaporation were repeated 3 times to form three alternating photonic crystal layers. The photoresist was removed by a thermal cycle up to 550° C. to result in the alternating low-high index stacks as shown in FIG. 6-FIG. 8.

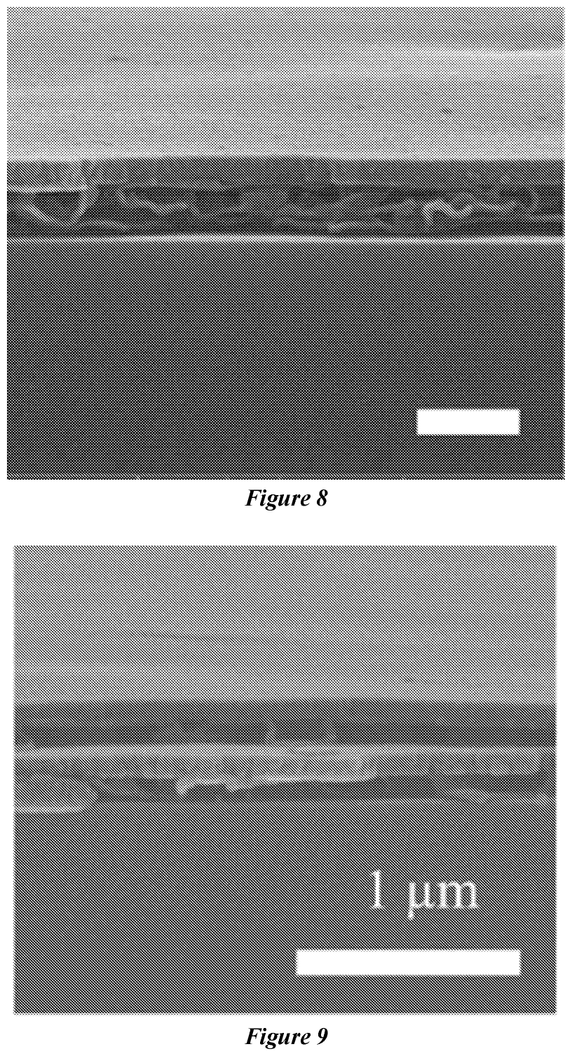

The cross-sectional SEM images in FIG. 6-FIG. 8 show one pair of the 180/80, 300/135, and 500/220 nm Al₂O₃ nanolattice/TiO₂ stack, respectively. In the case of the 180/80 nm pair, the thickness of the TiO₂ layer is about 80 nm as the designed height, but the nanolattice thickness was only about 130 nm. It was found that the side wall of the nanolattice was slightly curved, and this may cause the 19.2% difference between the desired and actual fabricated height of the nanolattice layer in the 180/80 nm pair. The same phenomenon, but to a more serious degree, was also observed for the 300/135 and 500/220 nm pairs; The resulting height of the nanolattice layer was about 167.0 and 249.1 nm, which shows a 30.6% and 34.8% reduction in the height of the repeating unit, respectively. The cross-sectional SEM images in FIG. 7 and FIG. 8 also demonstrate the collapse and deformation of the nanolattice layer under the solid TiO₂ film.

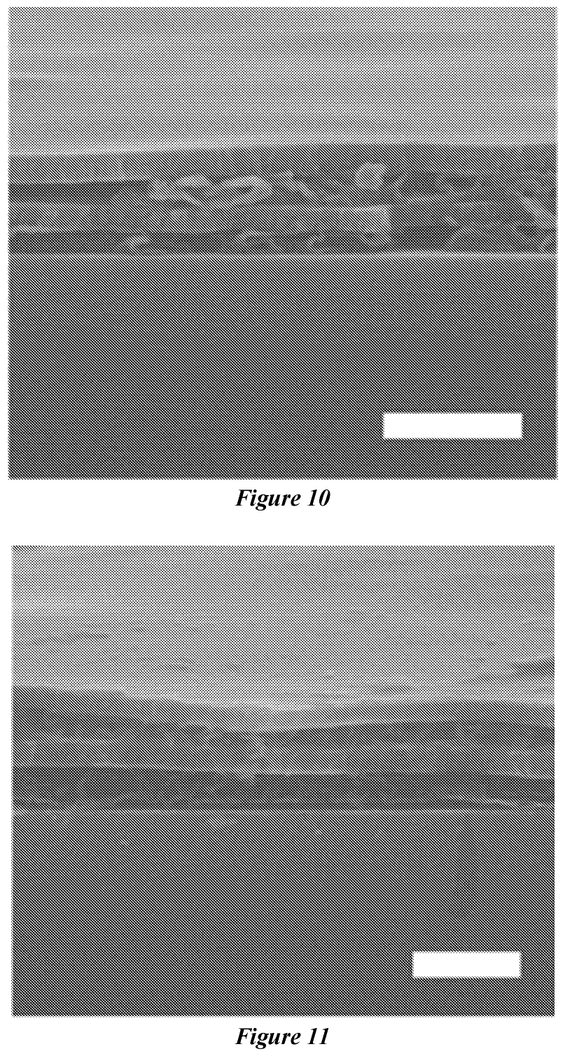

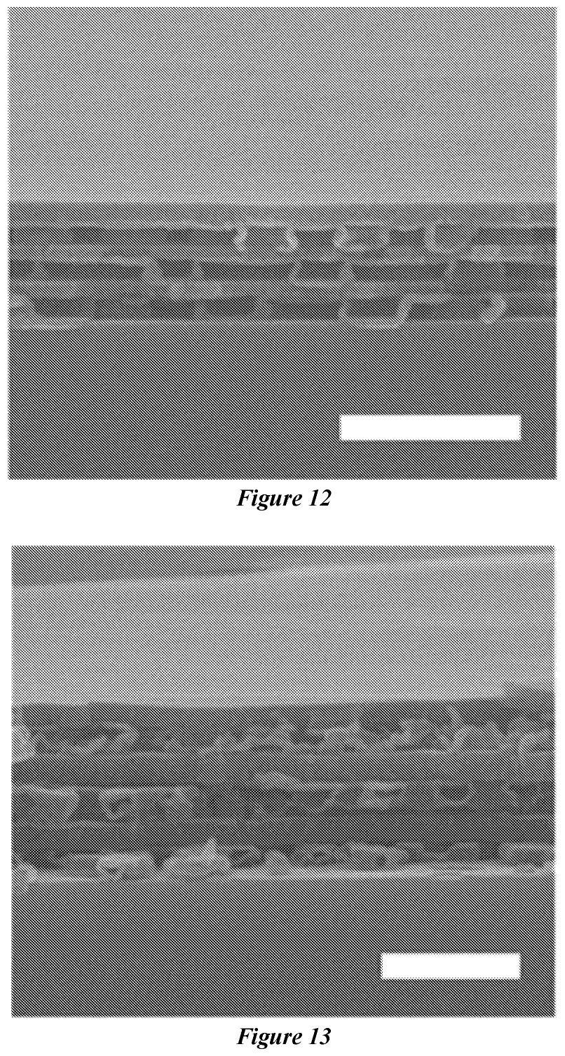

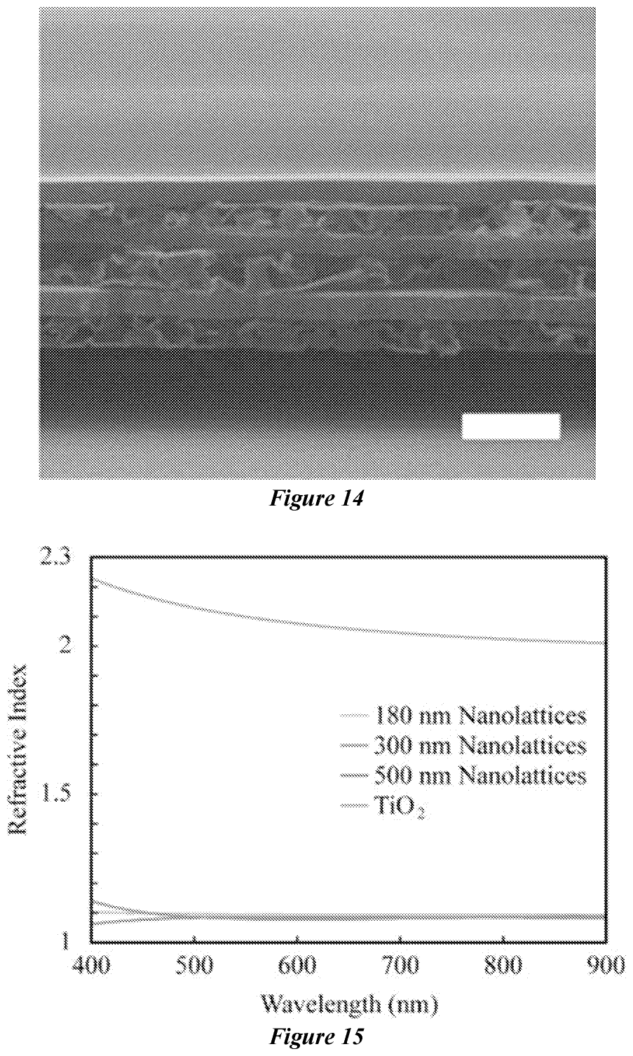

The same situation was found on the samples of two and three pairs of the Al₂O₃ nanolattice/TiO₂ repeating unit with 180/80, 300/135, and 500/220 nm thicknesses as shown in the FIG. 9-FIG. 14. The cross-sectional SEM images of the 180/80 nm samples with two and three repeating pairs show clear nanolattice structures (FIG. 9 and FIG. 12). However, systematic deformation and collapse of the nanolattice structure was found for the 300/135 and 500/220 nm structures, as shown in FIG. 10, FIG. 11, FIG. 13, and FIG. 14, resulting in much lower nanolattice height in the samples. The reduction of the nanolattice height was 19.1% and 34.4% for the two-pair samples, and the height reduction of the three-pair samples was 10.8% and 20.1%, respectively. The reduction of the repeating unit height was not consistent for the one through three pairs for the 300/135 and 500/220 nanolattice photonic crystals. Moreover, the reduction ratio of each nanolattice layer in the nanolattice photonic crystal was not uniform either. The deformation of the nanolattice can be attributed to the photoresist removal process; during the thermal cycle the resist changes from solid to liquid and to vapor phase and results in an uneven surface tension acting on the nanolattice. The layered geometry of the nanolattice photonic crystal also constrains the escape of the photoresist flow, which further deteriorates the nanolattice layer resulting in the shrinkage and collapse of the nanolattice layers. Employing a plasma etching process to remove the photoresist or increasing the ALD film thickness of the nanolattice can potentially mitigate the nanolattice collapse issue.

Characterization of the Optical Properties of the Nanolattice Photonic Crystal Reflectors. The refractive index of the Al₂O₃ nanolattice with different thicknesses and the TiO₂ layer were examined by the ellipsometry. Because the nanolattice is a highly porous, the refractive index of the nanolattice with various thickness is close to 1.1, as shown in FIG. 15. Note the index is fairly constant and independent of film thickness since the ALD thickness of the nanolattice was kept constant. Slight index variation was observed in the UV around 400 nm due to material dispersion. The measured refractive index of the TiO₂ layer made by the e-beam evaporation process was about 2.2 to 2.0, which results in a contrast between the low-high index materials of around 1.0.

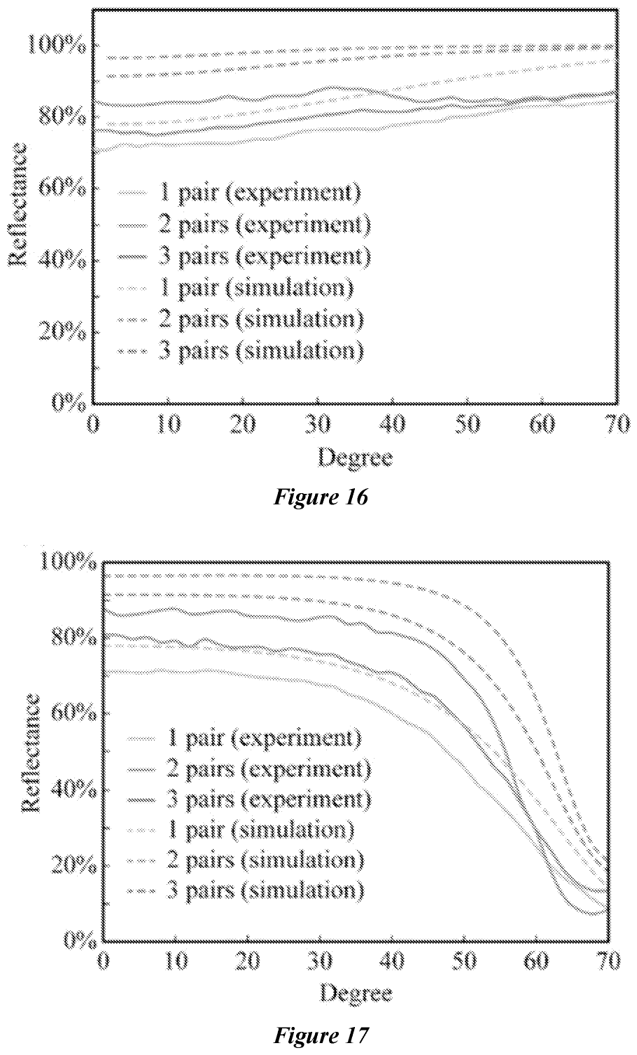

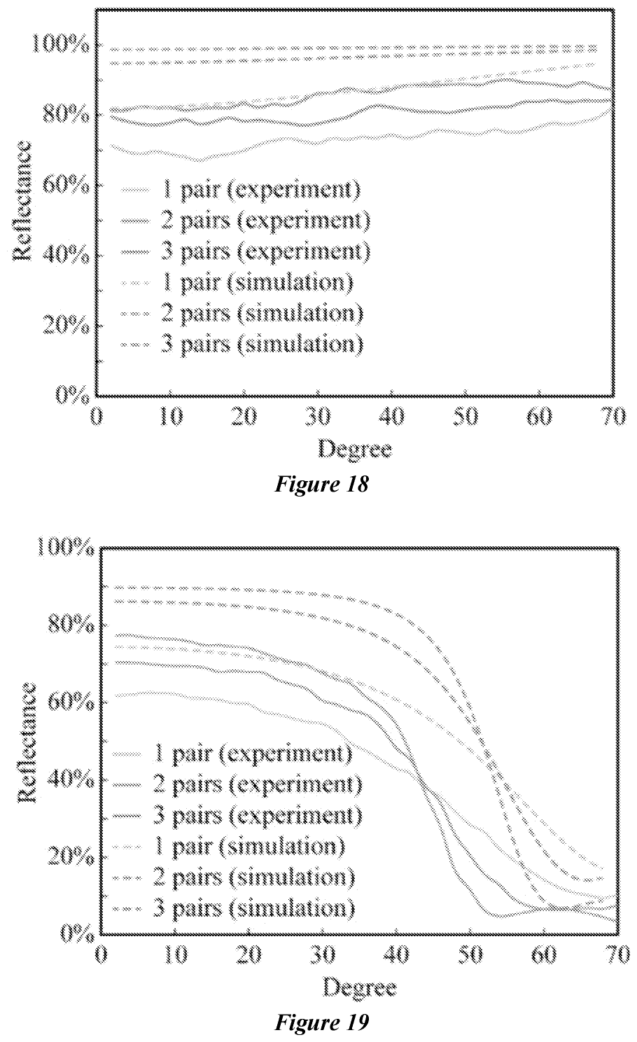

The specular reflectance of the 180 nm/80 nm Al₂O₃ nanolattice/TiO₂ reflectors were characterized with 633 and 532 nm lasers as shown in the FIG. 16-FIG. 19. The TE mode reflectance of the 532 nm laser over different incidence angles is shown in FIG. 16. Here, the nanolattice photonic crystal with low-high index repeating numbers of from one to three were characterized by a 532 nm laser with an incidence angle of from 0° to 70° are shown in the solid lines and the corresponding rigorous coupled-wave analysis models are shown as the dashed lines (FIG. 16). For the nanolattice photonic crystal with one pair of 180/80 nm Al₂O₃/TiO₂ stack, the specular reflectance is 70.8% at normal incident and 84.5% at 70°. The rigorous coupled-wave analysis simulation demonstrates the same trend that the specular reflectance is 77.8% and 95.9% at 0° and 70°, respectively. In these simulations, the nanolattice/TiO₂ layer thickness is adjusted to 125 nm/80 nm as the cross-section SEM images show. It can be observed the nanolattice photonic crystal reflector can achieve higher reflectance as the repeating pair number increases from one to three. In the case of the reflector with two repeating pairs, the specular reflectance reaches 76.2% and 86.7%, respectively, at 0° and 70° of incident angle. As the pair number increases to three, the specular reflectance can be as high as 84. % and 87.2% at 0° and 70° of incidence. However, the experiment results show that the reflectance enhancement as the number of pairs increases is not as much as predicted by the simulation. This might be attributed to the defects of the stack. The yield rate would decrease exponentially as the fabrication process increases, resulting in higher scattering losses. The mismatch of the specular reflectance becomes worse under higher incident angles, which can be attributed to the projection area of the laser beam, which is proportional to 1/cos θ, meaning more defects would be involved at higher angles. The same phenomenon can be found in the TM case, as shown in FIG. 17. The TE and TM mode specular reflectance at 633 nm wavelength are shown in FIG. 18 and FIG. 19. The measurement results also generally follow the trend predicted by the simulations, but at a slightly lower efficiency. Note a sharp drop in TM reflection observed at high incident angle due to Brewster angle effects.

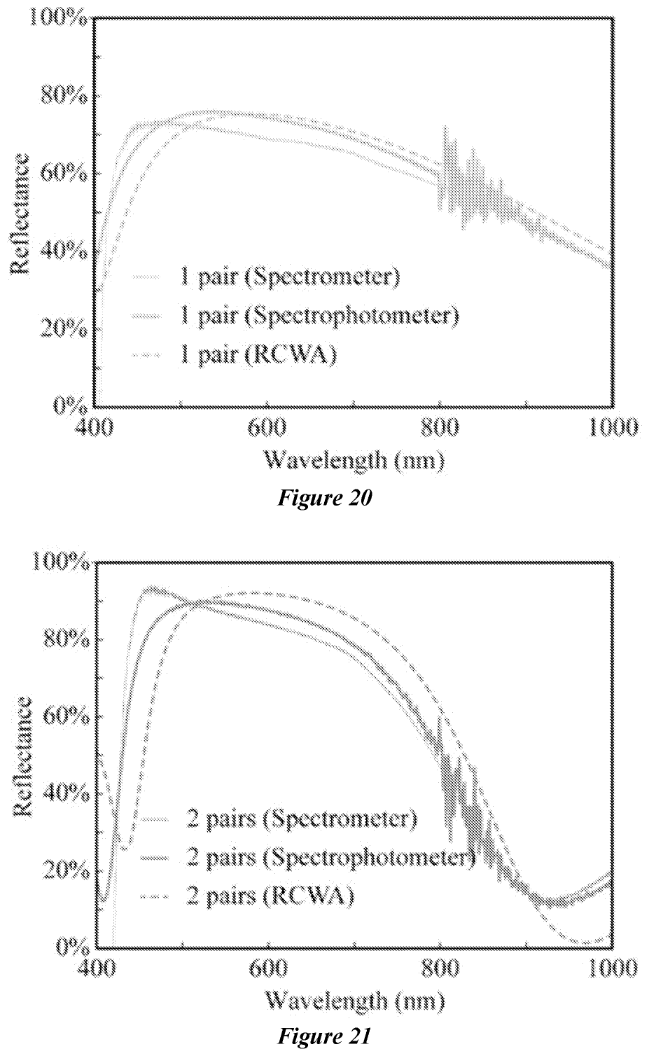

The broadband specular reflectance from 400 to 1000 nm under normal incidence was measured by spectrometry (HR4PRO-UV-VIS-ES, OceanView) and spectrophotometry (Cary 000 UV-Vis-NIR, Agilent), as shown in FIG. 20-FIG. 23. The spectrometer is employed for the initial examination. Two measurement systems were used to examine the systematic errors in the metrology systems. The reflectance of the reflector with one pair of nanolattice-TiO₂ is shown in FIG. 20. The measurement result for both spectrometer and spectrophotometer agree with the rigorous coupled-wave analysis simulation well (FIG. 20). The simulation predicts a maximum reflectance of 75.2% at 580 nm and the spectrometer and spectrophotometer got a peak value of 73.1% and 75.9% at 502 nm and 538 nm, respectively (FIG. 20). There is a region of the reflectance with significant noise in the spectrophotometer measurement in the range of 800 to 900 nm, which is due to the grating and detector change in the system.

The calculated reflectance of the nanolattice reflector with two repeating pair, as shown in FIG. 21, is over 80% reflectance in the range of 490 to 730 nm, and the calculated peak value was 92.10% at 80 nm by the rigorous coupled-wave analysis simulation. The experimental result fits the trend, and the data from the spectrometer shows that the reflectance is able to reach 80% from 440 to 650 nm and a peak value of 93.3% at 477 nm (FIG. 21). The spectrophotometer measurement shows that in the range of 458 to 690 nm, the reflectance of the reflector is over 80% with a peak value of 89.9% at 525 nm (FIG. 21).

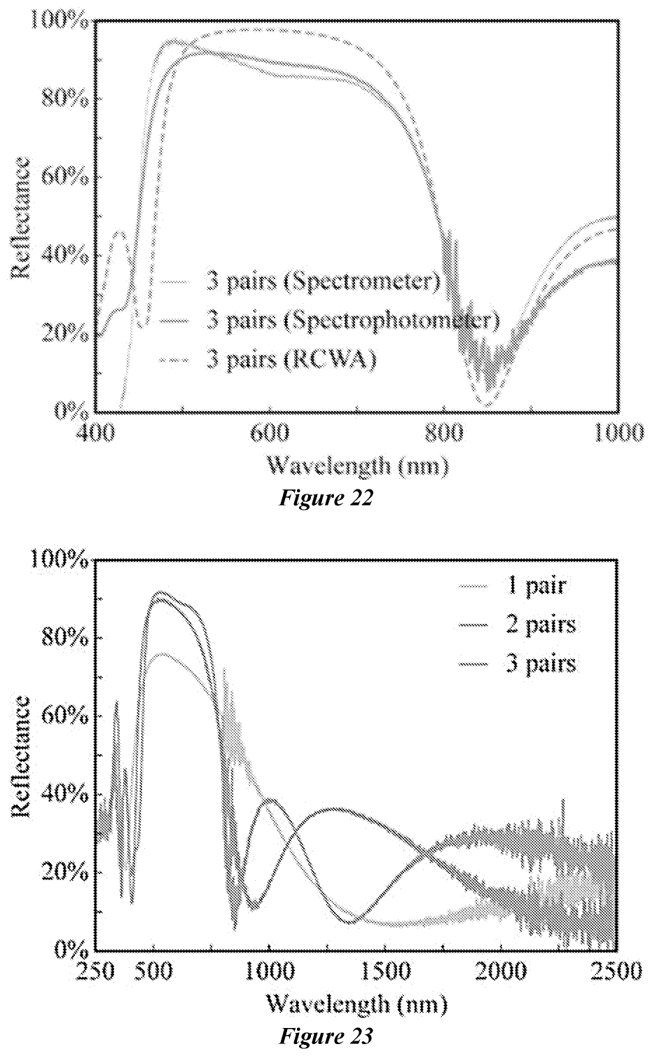

Spectrometer and spectrophotometer measurements of the reflector with three repeating units show over 80% of reflectance in the range of 460 to 728 nm and 470 to 732 nm with the peak values of 95.3% at 488 nm and 91.9% at 527 nm, respectively (FIG. 22). The corresponding simulation result predicts the 80-percent-reflectance range is from 490 to 750 nm with the peak value of 97.8% at 80 nm (FIG. 22).

The experimental results of reflectors with one pair, two pairs, and three pairs of the repeating show the stopband of the periodic stack is a little bit shifted from the simulation. This might be due to the defects or collapses of the nanolattice, which result in the average nanolattice height being shorter than the value observed in the cross-section SEM images.

FIG. 23 demonstrates the reflectance of the 180/80 nm dielectric mirrors with different numbers of repeating units over the entire solar spectrum. The stopband of the 180/80 nm dielectric mirror is located in the range of 500 to 750 nm and has less than 40% of reflectance out of the stopband range, which is similar to the reflectance of silicon surface.

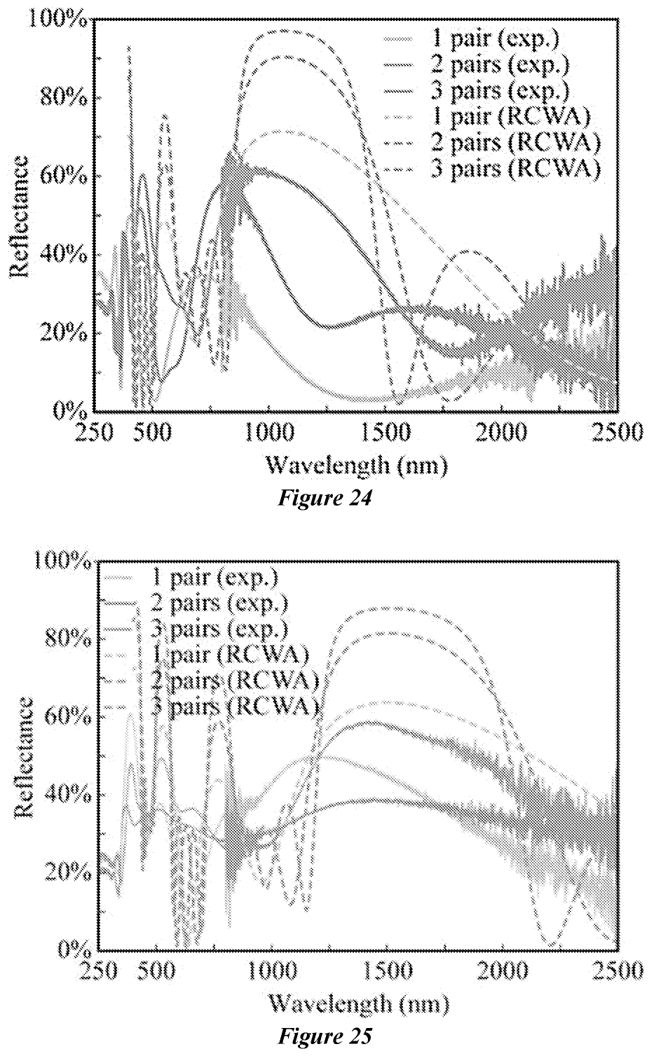

The broadband reflectance of the nanolattice photonic crystal reflector with 300/135 and 500/220 nm Al₂O₃/TiO₂ units were also characterized by spectrophotometer as shown in the FIG. 24-FIG. 25. The experimental and simulated specular reflectance of the 300/135 nm reflectors from 250 to 2500 nm are shown in FIG. 24. In the simulation, because the nanolattice has systematic collapse, as illustrated in the cross-section SEM images, the thickness of the periodic unit in the model is set up as 220/135 nm. The broadband reflectance measurements show the reflectance increasing as the unit pair number increases. The observed bandgap position meets the prediction from the rigorous coupled-wave analysis simulation, e.g. at 800 to 1500 nm. However, the measured reflectance of the reflector with three repeating pairs barely reaches 60%, which is much lower than the simulation result. The stopband of the reflector is based on the index contrast of the alternating layers, and the collapse of the nanolattice layer increases the effective index of the nanolattice layer, therefore degrading the results. The same phenomenon can be found in the 500/220 nm reflector as shown in FIG. 25. The highest reflectance of the dielectric mirror with three pairs of the repeating unit is 64.7% at 1427 nm, however, the corresponding reflectance from simulation is 96.3%. As the result, improving the structure stability of the nanolattice layers in the dielectric mirror fabrication can improve their experimental performance.

Challenges. The nanolattice/TiO₂ photonic crystal reflectors herein demonstrate the feasibility of high reflectance in solar spectrum, which is predicted in the rigorous coupled-wave analysis simulation. The proof-of-concept principle was successfully demonstrated using nanolattice layers with 180/80 nm repeating units, which matched the prediction of the numerical simulations well. The high contrast between the nanolattice/TiO₂ also results a wider bandgap with fewer repeating units. The proposed nanolattice photonic crystal achieves a peak reflectance of 91.9% with a FWHM of 347 nm using only three pairs of repeating units, which agrees well with the rigorous coupled-wave analysis results (FWHM of 335 nm from 465 nm to 800 nm). Meanwhile, existing research using an oblique angle deposition (OAD) method to control the index contrast must use two sets of five repeating pairs to reach 95% of peak reflectance with a FWHM of 320 nm (Leem et al. Opt. Express, OE 2014, 22, 1819-1826).

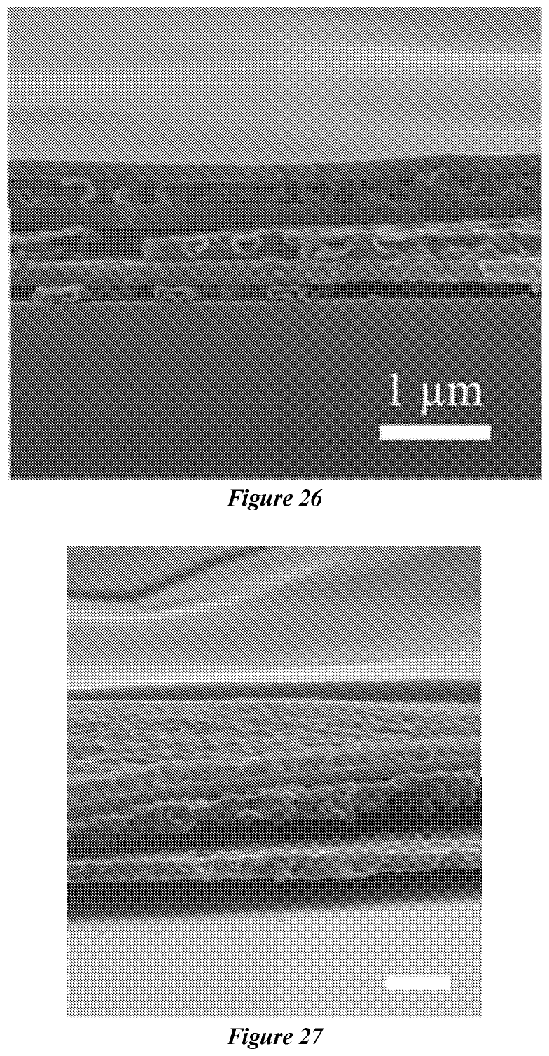

The experimental reflectance behavior of the nanolattice photonic crystal reflectors with thicker nanolattice layers did not demonstrate the corresponding predicted optical properties. The major reason is because these nanolattice layers are more likely to collapse or deform during the photoresist removing process, which results the inconsistency of the nanolattice thickness and volume fraction as shown in FIG. 26-FIG. 27. In FIG. 26, it can be seen that the bottom layer of nanolattice has deformed dramatically due to the systematic collapse, and the nanolattice thickness therefore becomes much shorter. Since the stopband of the dielectric reflector scales with the periodically varying refractive index along the thickness direction, the deformation of the nanolattice layer reduces the periodicity and further reduces the reflectance as shown in FIG. 24-FIG. 25. This is more problematic when the collapse is not uniform, resulting in non-periodic index modulation, which degrades the photonic crystal response. This issue can be solved by using a thicker ALD layer for a stronger nanolattice layer. Another challenge of this approach is the defects of the reflectors, which can be attributed to the particle assembly process. The defects lead to diffused reflectance and non-uniformity of the nanolattice layers. The defect issue can be ameliorated by improving the lithography yield rate and optimizing the photoresist removal process.

Conclusions. Herein, two applications of the nanolattice multilayer fabrication technology for photonics have been demonstrated. The process was used to fabricate a four-layer graded refractive index (GRIN) antireflection structure that reduces more than 90% of specular reflectance at 633 nm wavelength and reflects less than 6% over broadband from a silicon substrate. The multilayer nanolattice approach was also employed for the fabrication of high index contrast all-dielectric photonic crystal reflectors. The resulting reflectors had high reflectance in the visible light range and high transparency in NIR spectrum. By combining multiple photonic crystal reflectors with different stopbands, a reflector with selective dispersion behavior can be achieved. This work demonstrates the potential of the nanolattice multilayer stack technology, which can be further applied for optical multilayers, radiation shielding, and radiation cooling.

### Example 2—Fabrication of Multilayer Photonic Reflectors Using Periodic Nanolattices

The advent of nanofabrication has opened tremendous opportunities for acoustics, photonics, and electronics industries, enabling mass manufacturing of materials having superior properties than bulk, and exhibiting unexpected effects due to scaling laws (Jang et al. Adv. Funct. Mater. 2007, 17, 3027-3041; Jeon et al. PNAS, 2004, 101, 12428-12433). The presence of periodic nanostructures can further amplify the effects due to their ordered geometry. At the macroscale, the nanostructures provide enhanced strength to weight ratios, and result in improved stiffness for a given density. With regards to thermal properties, the porous nanostructures can potentially reduce thermal conductivity. Optically, the presence of porous nanostructures can reduce the effective refractive indices to be close to that of air (Zhang et al. Adv. Func. Materials, 2015, 25, 6644-6649). This allows the nanostructures to serve as the low-index medium in Bragg reflectors or 1-dimensional photonic crystals, with multiple layers of high and low refractive indices to achieve perfect reflectivity over a wavelength band. The proposed research involves using multilayer nanostructures made by stacking porous nanolattice and solid layers, which can result in a highly effective dielectric mirror.

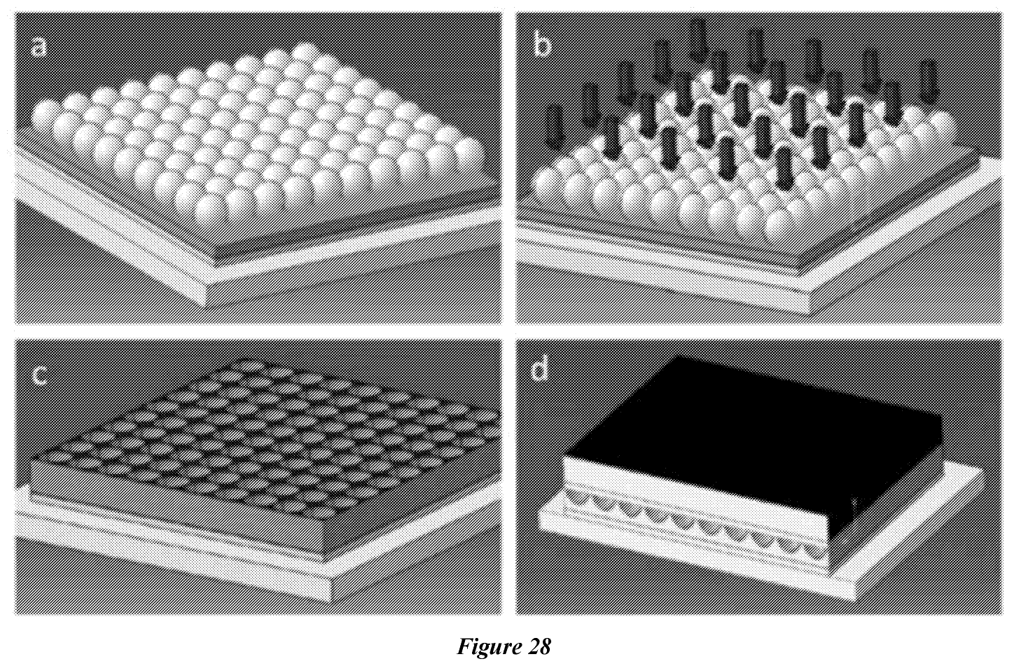

The schematic of sample fabrication for the nanolattice reflector is depicted in FIG. 28. In this work, self-assembly of colloidal nanospheres with 500 nm diameter is achieved by the tendency of surfaces to maintain the lowest surface energy. The assembled spheres are used as a near-field phase shift mask and the samples were then subjected to UV lithography using a 325 nm laser with 90, 100, 110 and 120 mJ/cm² dose exposures (panel (b) of FIG. 28). The monolayer of nanospheres results in formation of periodic 3D nanostructures as is governed by Talbot effect (Chang et al. Nano Lett. 2011, 11(6), 2533-2537). Over this structure, a conformal coating of Al₂O₃ was deposited using atomic layer deposition (ALD) to a thickness of 20 nm within the structure (panel (c) in FIG. 28). Layer height of the porous nanostructure was maintained at 120 nm, as a trade-off between strong but low aspect ratios versus tall structures with high porosity but low strength. The conformal coating allows the photoresist to act as a sacrificial template for the nanolattice (Chen at al. Adv. Materials Interfaces, 2021, 17, 2170092). is followed by coating another layer of PFI 88 resist around 350 nm to planarize the nanolattice, followed by deposition of 80 nm thick TiO₂ using electron beam evaporation to create a solid layer (panel (d) in FIG. 28). The sequence of steps could be repeated with different exposure parameters and different materials to stack 3D layers to desired thickness. Finally, the structure is baked in oven at 550° C. to remove the photoresist.

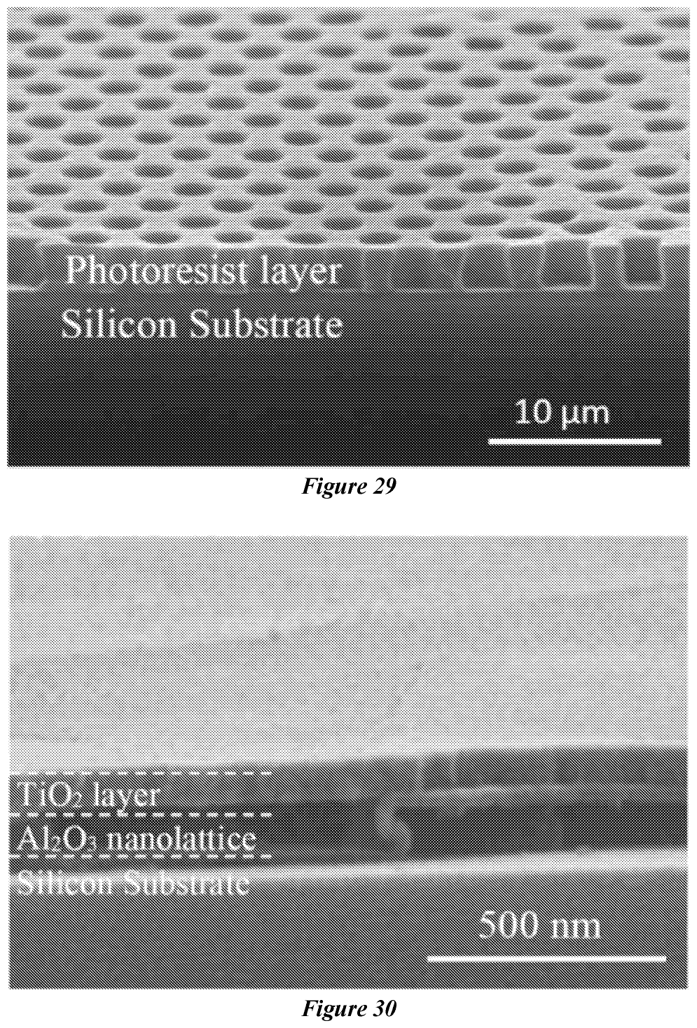

A cross-sectional SEM image of samples with a 100 mJ/cm² exposure dose is shown in FIG. 29. The cross-section of the layer is more consistent for 100 mJ/cm² dose than the higher doses used, indicating that the samples prepared using doses of 110 and 120 mJ/cm² were overexposed. Moreover, diameter of the exposed features was larger in doses higher than 100 mJ/cm². Information such as the structure depth, geometry, and filling ratio of the periodic hexagonal-close-packed arrangement can be inspected by the feature size captured from SEM images. The result of stacking a solid film on top of the nanolattice is shown in FIG. 30. The Al₂O₃ porous layer is observed to be 130 nm thick, and the solid TiO₂ film is 80 nm thick. The porous layer allows better thermal insulation, low index, and maintains the mechanical strength, which can improve reflectance as the number of layers is increased. The aim of this work is to fabricate a 3-layer nanostructure and characterize its optical properties. Moreover, post-fabrication coating on aluminum (on top) would enhance the reflectivity of the sample. The structure has significant applications in photonics, to improve the reflectivity parameters.

### Example 3—Fabrication of Multilayer Photonic Reflectors Using Periodic Nanolattices

Applications of 3D nanostructures include thermal transport and battery electrodes, among others. Nanolattices show high deformability, recoverability, and high stiffness. Heat transport occurs in nanolattices comprising carbon and Al₂O₃ truss, resulting in thermal isolation. Nanorods, for example, can act as current collectors (e.g., Cu nanorods) and anodes (e.g., TiO₂ nanorods) for micro-batteries, which can improve efficiencies.

Photonic crystals have a periodic dielectric profile and can prevent propagation of light with certain wavelengths in specific polarization directions in the crystal.

An example application is a Bragg reflector, with multiple layers of high and low refractive index materials. The low thickness of the nanolattices can increase the contrast of the low/high index pair. Low-index porous materials have porosity, low stiffness, and high scattering. The existing solid with the lowers index is CaF₂, which has a refractive index of ˜1.39. A significant index mismatch is essential for a Bragg reflector and fabrication of photonic crystals with a high mismatch is difficult using traditional solid materials. 3D periodic nanostructures can be fabricated using nanosphere arrays assembled as phase elements with a porosity of about 50% (Chang et al. Nano Lett. 2011, 11(6), 2533-2537). This procedure eliminates the need for a physical mask, and instead relies on self-assembly. The assembled spheres are used as a near-field phase shift mask and subjected to UV illumination. The monolayer of nanospheres results in formation of periodic 3D nanostructures as is governed by Talbot effect (e.g., intensity patterns repeated with an axial period) (Chang et al. Nano Lett. 2011, 11(6), 2533-2537).

Atomic layer deposition (ALD) is a process for thin film deposition of different materials, such as oxides and/or ceramics. 3D thin-shell nanolattices can be formed by applying a conformal coating onto the 3D periodic nanostructures described above using ALD. The photoresist can subsequently be removed to provide a hollow structure, for example having a low index of ˜1.025. Removal of the photoresist increases the porosity (void space) of the material to about 90%, which contributes to the low index of the material and in turn provides a better high/low index contrast, resulting in higher reflectance.

There currently is an absence of multilayer photonic crystals with high/low index mismatch. Further, there is a lack of integration of solid layers in multilayer 3D stacked structures and a lack of experimental results for depositing different geometries.

Described herein is a process for integrating a multilayer nanolattice material with high index mismatch, for example which can be used as a Bragg reflector. The reflectance of these structures can be measured using spectrophotometry and compared with computational values.

The multilayer 3D nanostructures can be made using a procedure similar to that shown in FIG. 5 and FIG. 28 and as described above.

First, PFI 88 positive resist (PR) (300 nm) and a 100 nm ARC coating are deposited to improve stability and reduce transmittance. A monolayer of 300 nm diameter spheres is then assembled thereon. The assembled spheres are then subjected to UV lithography using a 110 mJ/cm² dose to form periodic 3D nanostructures. Over this structure, ALD is then used to deposit Al₂O₃ to a thickness of 20 nm (200 ALD cycles). A buffer layer resist layer is then deposited for stability and planarization; the buffer layer coating prevents collapse and provides a stable base for the subsequent steps. A solid layer, such as TiO₂, is then deposited (e.g., to a thickness of 80 nm) using, for example, PVD, ALD, etc. The period of the nanolattice photonic crystal is controlled by the thickness of the photoresist and TiO₂ layers.

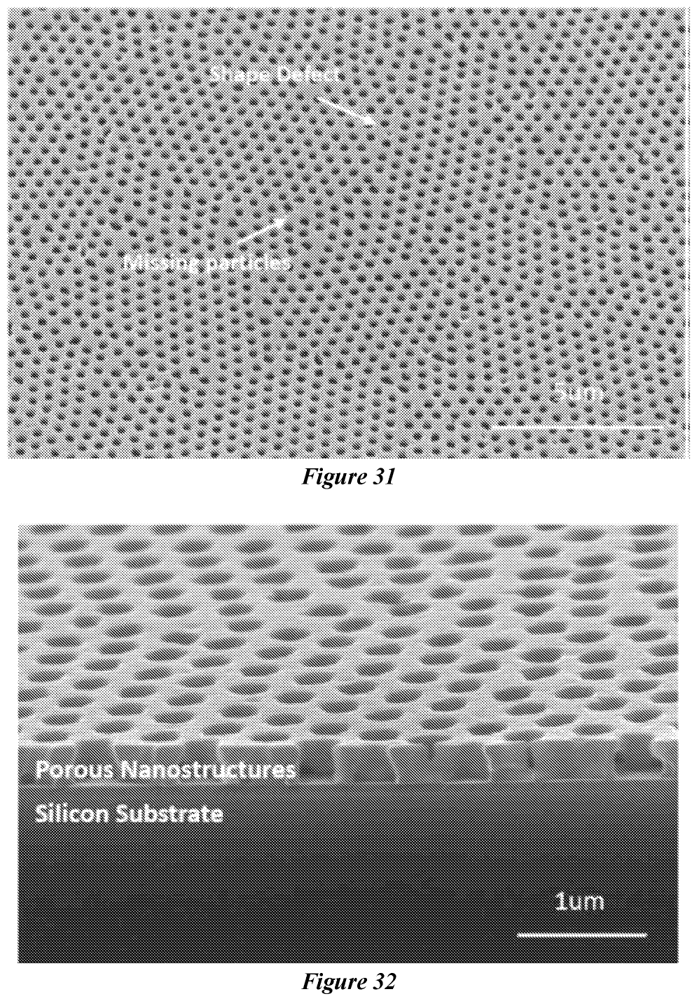

The monolayer of nanospheres self-assemble into hexagonal close packed structures based on low surface energy and capillary forces. Shape and point defects can occur in the assembled nanosphere layer, as shown in FIG. 31 and FIG. 32. Separation between regions of packing can result in crack formation. The presence of inclusions and high energy areas result in void formation.

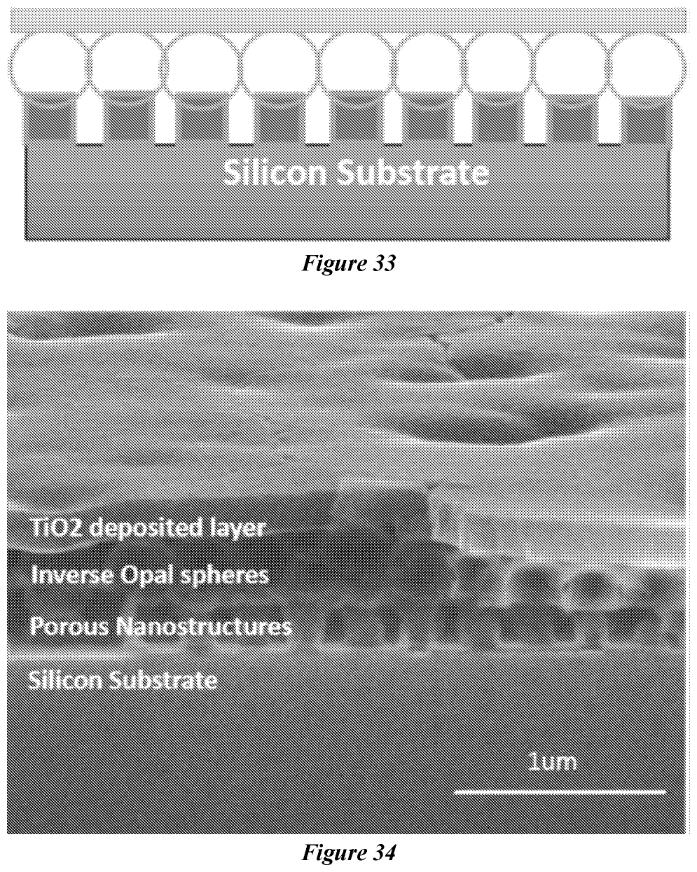

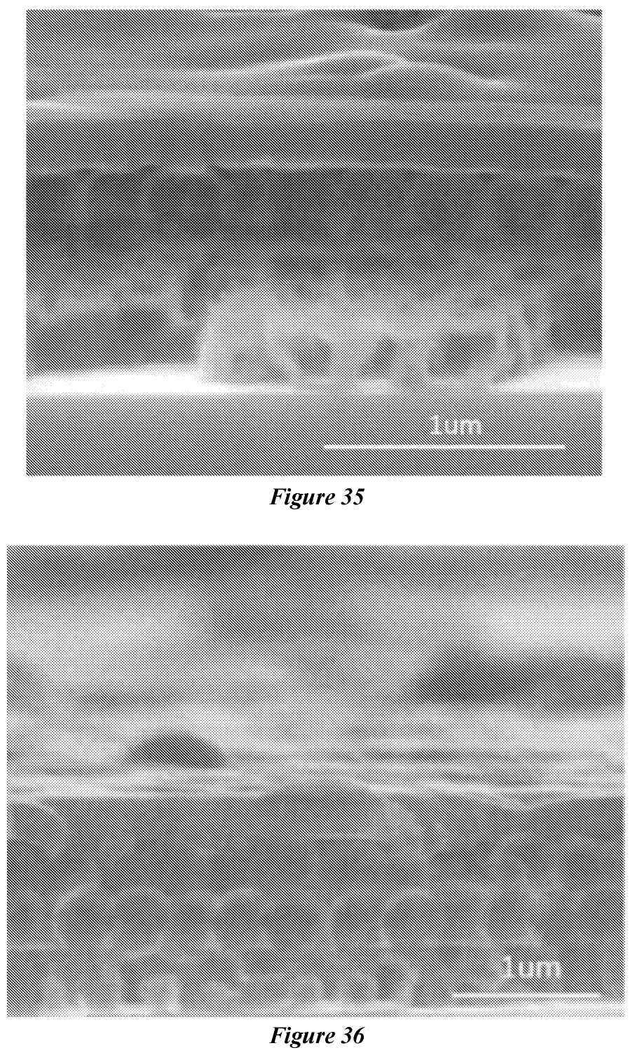

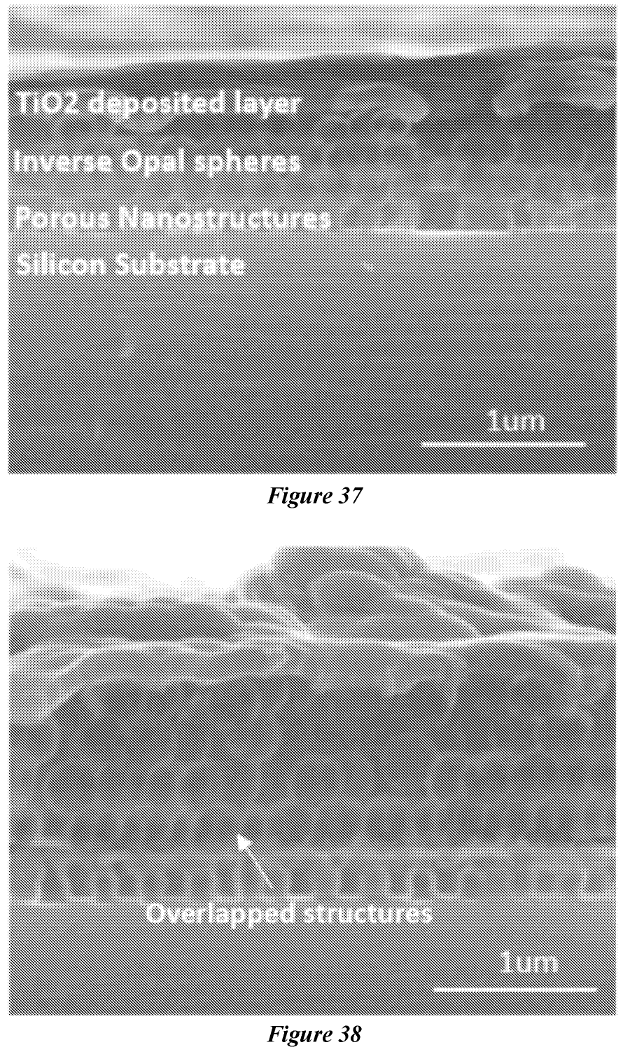

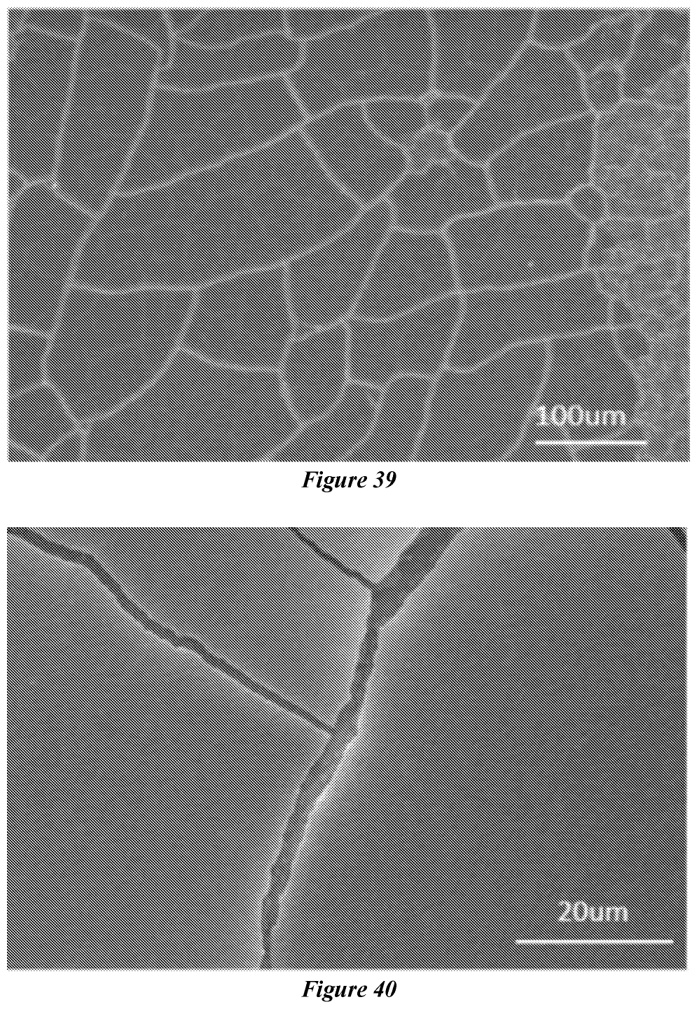

Multilayer stacks were attempted using the porous nanostructures and single layer inverse opal structures (shown schematically in FIG. 33) and multiple inverse opal stacks. However, experimentally these structures exhibited poor mechanical stability and overlapping structures can cause a deviation in index (FIG. 34-FIG. 38). Surface undulations increased as the number of inverse opal stacks increased (FIG. 34-FIG. 38). Polystyrene spheres after ultrasound cleaning results in inverse opal structures. Control of ultrasound cleaning time improves structural stability.

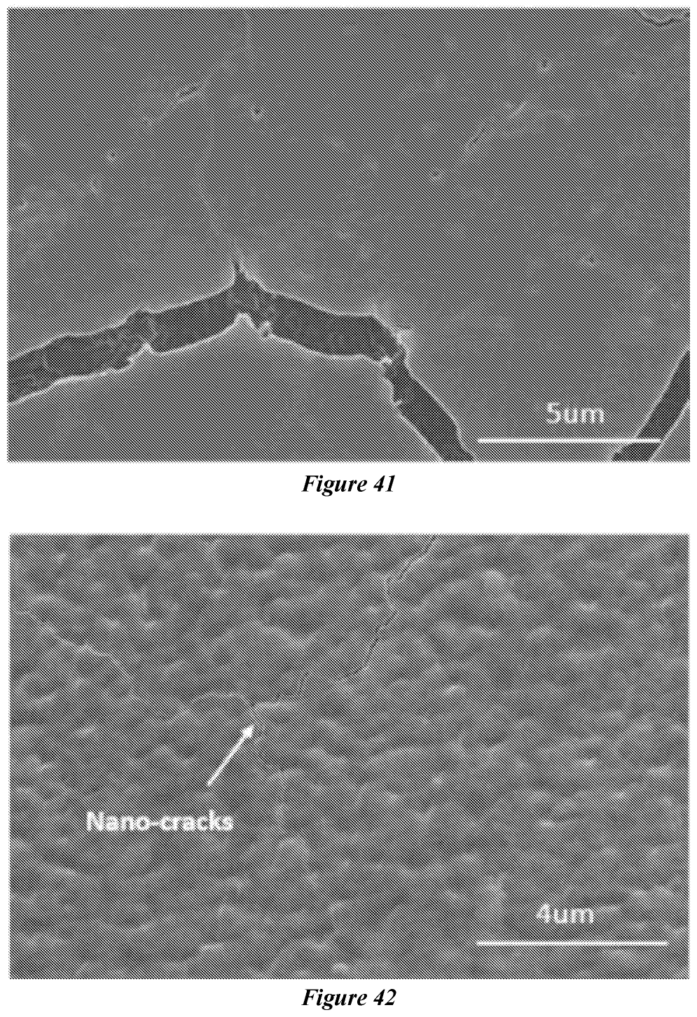

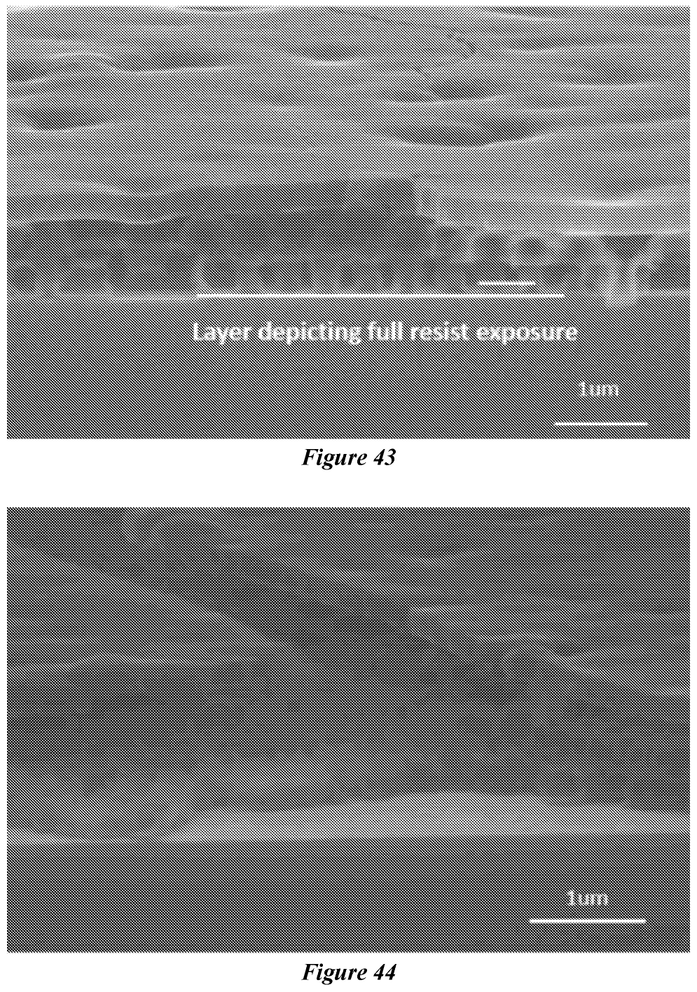

Due to high thermal cycle and inclusions, macro and micro crack formation was promoted; inclusions initiate micro and nano cracks (FIG. 39-FIG. 42). A defined thin layer of ARC and Al₂O₃ was observed (FIG. 43-FIG. 44). Post process baking removes all resist, resulting in Al₂O₃ depositing on the ARC layer. Cracks only occur along the surface; the inverse opal structures are not affected by the high ramp rate.

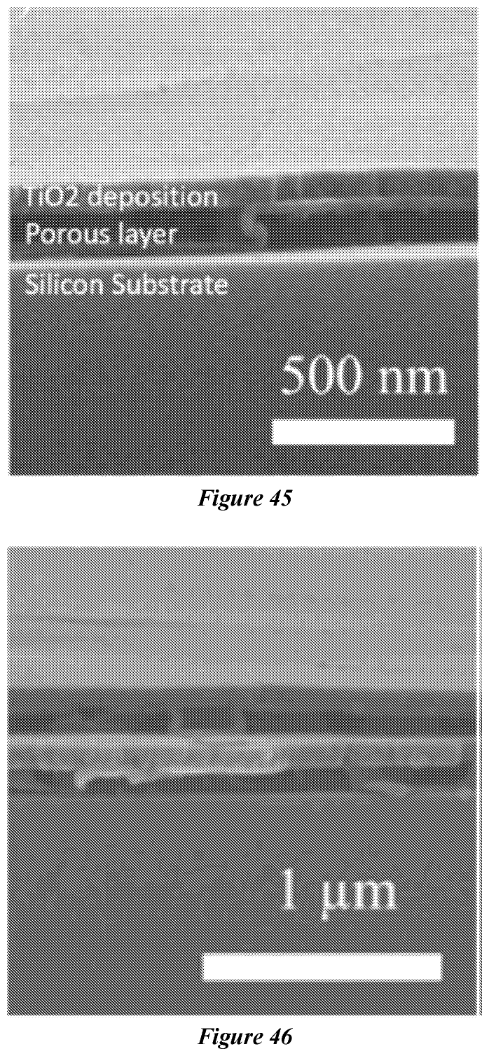

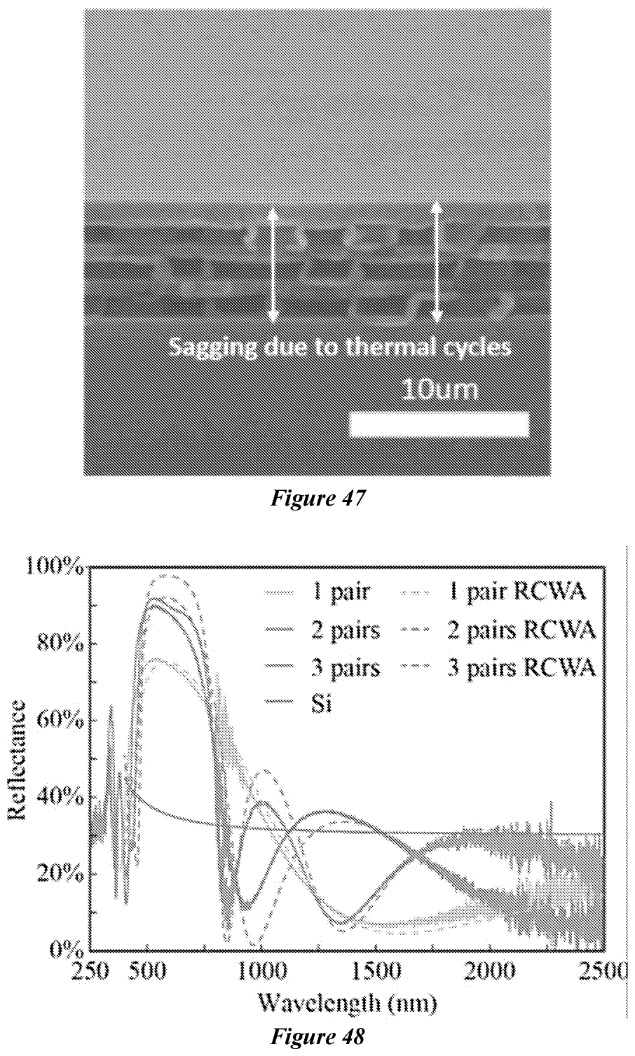

Solid layer integrated stacked nanolattices were formed from structures having Al₂O₃ walls of 20 nm thickness with a TiO₂ film deposited on top of the porous layer. TiO₂ depositions on the holes combined with backing cause collapse of the porous layer (FIG. 45-FIG. 47).

A photonic crystal was made from a nanolattice and TiO₂ pair with thicknesses of 180 nm and 80 nm, respectively. The broadband specular reflectance of the 180/80 nm Al₂O₃/TiO₂ dielectric reflectors under normal incidence with one pair of the repeating unit, two pairs of the repeating unit, and three pairs of the repeating unit was measured experimentally and modeled using rigorous coupled-wave analysis (RCWA) (FIG. 48). The three stack repeating unit exhibited a peak reflectance of 91.9% at 527 nm with a FWHM of 347 nm (from 450 nm to 797 nm) (FIG. 48). A lower reflectance was observed experimentally compared to the rigorous coupled-wave analysis model due to assembly defects, structure collapse, film cracking, etc. (FIG. 48).

In summary, surface undulations were present in multilayer nanostructures with inverse opaline structures and absent in multilayer photonic crystals. The presence of polystyrene layers aids in the fabrication of inverse opaline structures, with high index mismatch, and poor mechanical stability. Process parameters can be controlled to reduce surface undulations and improve the mechanical properties of inverse opaline structures.

Fabrication of nanostructures with an incorporation of solid high index layer and porous low index layer provides highest possible mismatch. The physical properties of the multilayer structures, and their variation with number of layers, can be investigated further.

### Example 4—Multilayer Photonic Nanolattice Reflectors

For existing Bragg reflector technologies, two different kinds of dielectric materials are alternately layered to make a one-dimensional photonic crystal. However, the lowest refractive index of the low index layer is limited by the material properties of the dielectric material if a solid planar dielectric layers is employed. The materials described herein employ nanolattices as the low-index layer which can achieve near unity refractive index and significantly increases the refractive index contrast of the high vs. low refractive index materials. A high-contrast dielectric reflector can result in higher reflectance and broader bandwidth with fewer repeating units.

Described herein is a fabrication method for high contrast nanolattice dielectric reflectors by layering 3D nanolattices and planar dielectric layers. Further described herein are high efficiency, broadband dielectric reflectors with low thermal conductivity and that are light weight. These dielectric reflectors results in higher reflectance and broader bandwidth but with fewer repeating units. The materials can also be thermally insulating and be light weight.

Provided herein is a dielectric reflector prepared by stacking of alternating nanolattices and dielectric layers. The periodic optical properties of the multilayer reflector can reach high reflectance for a specific wavelength band. Reflectance of the reflector can be controlled by the thickness and refraction index of the nanolattices and dielectric layers. This approach is based on the concept of Bragg reflectors which include high and low refractive index films. Because the nanolattice layer can reach near unity refractive index, the reflectance and bandwidth of the materials described herein can be much higher than a dielectric reflector made by other alternating dielectric materials. The nanolattice reflector can be patterned using 3D nanolithography, phase-shift lithography, holographic lithography or other additive manufacturing processes. Then, a thin shell of an oxide layer is deposited onto the nanostructures by atomic layer deposition (ALD) to protect the underlying structures. A layer of buffer material is then coated onto the ALD-protected nanostructures. The flat top surface of the buffer material is used to deposit a planar layer of high index dielectric material. After optionally repeating the processes, the photoresist nanostructures and buffer materials can be removed by dry etching or thermal cycle. The ALD oxide shell and the dielectric material will remain and an alternating stacking of nanolattices and planar dielectric material can thus be made.

For existing technologies, two different kinds of dielectric materials are alternately layered to make a one-dimensional photonic crystal. However, the lowest refractive index of the low index layer is limited by the material properties of the dielectric material (generally around 1.39) if solid planar dielectric layers are employed. The materials described herein employ nanolattices as the low-index layer, which can achieve near unity refractive index and thus significantly increases the refractive index contrast of the layers. The materials herein therefore overcome the index contrast limitation of alternating layering posed by available naturally occurring materials. A high-contrast dielectric reflector can result in higher reflectance and broader bandwidth with fewer repeating units.

Defects in the nanolattices can result in scattering and reduce the reflectance of the dielectric reflector accordingly. This issue can be resolved, for example, by making the periodic 3D nanostructures with a conformal phase mask.

The reflectors described herein can also have low thermal conductivity due to the high porosity of the nanolattice. This can allow the nanolattice reflector to also function as a heat shield.

The materials described herein can be used, for example, as a photonic crystal, as a dielectric mirror, for thermal isolation, for selective reflection, or a combination thereof.

### Example 5—Precise Control of Optical Refractive Index in Nanolattices

Abstract. Recent developments in photonic devices, light field and AR/VR displays have resulted from a competitive development in the industries towards emergence of new technologies to improve user experience in the field of optics. These advances can be attributed to the rise of nanophotonics and metasurfaces, which can be designed to manipulate light more efficiently. In these elements the performance scales favorably to index contrast, making the use of low-index material important. Herein, the precise control of refractive indices of low-index nanolattice material is examined using 3D lithography and atomic layer deposition (ALD). This approach employs light diffraction from an array of colloidal assembly to create a photoresist template for ALD, allowing for precise control of the nanolattice geometry and its refractive index. The refractive indices of the fabricated nanolattices are characterized using spectroscopic ellipsometry and agrees well to the effective medium theory. By controlling the unit-cell geometry by designing the exposure and the thickness of the ALD process, the effective index of the nanolattice film can be precisely controlled to 3×10⁻⁴. The proposed technique opens a gamut of opportunities in index control and enable better performance in nanophotonic elements used in displays and other integrated devices.

Introduction. The advent of the ability to fabricate nanostructures resulted in a spectrum of possible developments in the field of integrated devices, materials science, and optics (CL Haynes et al. J Phys. Chem. B, 2001, 105(24), 5599-5611; Kaushik Pal et al. “Nanofabrication for Smart Nanosensor Applications, Chapter-2,” Micro and Nano Technologies MNT, 2020; M Cavallini et al. Synth. Met, 2004, 146(3), 283-286). These include improvements in functional materials, nanostructured surfaces, high-resolution sensors, nanoscale catalysts, and more efficient optoelectronics. Specifically, the field of photonics has faced a surge in number of applications for nanofabrication with techniques such as electron-beam, interference, and two photon lithography for fabrication of nanostructures. Bottom-up self-assembly techniques involving colloidal elements, block copolymers, and biological molecules have also lead to new photonic structures. In optoelectronics, nanofabrication has contributed to the improvement of 3D displays, flexible and wearable devices, and in high resolution patterning on the displays (J Li et al. J Display Technol. 2005, 1(1), 51-61; F F Muhammad et al. J Mater Sci: Mater Electron, 2017, 28, 14777-14786; T W Kelly et al. Optica, 2021, 8(6), 916-920; T Ishigure et al. J. Light. Technol., 1997, 15(11), 2095-2100).

In photonics applications, the refractive index contrast of the materials used can be an important factor in the device efficiency. An example is in Bragg reflectors and photonic crystals, which are used to enhance the range of colors in a display and can act as wavelength selective mirrors on 3D displays. They reflect a specific wavelength of light while transmitting the other wavelengths, and control of refractive index contrast is a parameter involved in the functionality of Bragg reflectors (C Marinelli et al. Appl. Phys. Lett., 2001, 79(25), 40-76; B S Kawasaki et al. Opt. Lett., 1978, 3(2), 66-68). Previous studies have shown that multilayer reflectors with alternating high and low refractive index improves the efficiency of reflecting and transmitting light. In optoelectronics, higher light extraction efficiency in solid-state lighting can be achieved by incorporating low index material with LED/OLEDs (Xiangyu Fu et al. Adv. Mater., 2021, 33(9), 2006801). Achieving a high refractive index mismatch between the alternating layers of a multilayer reflector require better understanding on the control of refractive index by fabrication methods (Jing-Qi Wang et al. Optics Communications, 2023, 532, 129251; IT Chen et al. Adv. Mater. Interfaces, 2021, 8(17), 2100690; V A Premnath et al. J. Vac. Sci. Technol., 2022, 40(6), 062803).

Existing methods to make low-index materials include tuning the effective index by changing the size and density of latex particles in a silica solute, resulting in the possibility of changing the porosity of the sol-gel film independent of the thickness of the film. The effective refractive indices are affected by the porous fraction measured by the alteration and the volume fraction of sol-gel mixture (F Guillemot et al. Chem. Mater. 2010, 22(9), 2822-2828). Further, researchers have explored the possibility of using oblique angle deposition, or glancing angle deposition (GLAD), to demonstrate SiO₂ nanorod layer with a refractive index of about 1.08. Such materials can be implemented in Bragg reflectors as the low-index layer to increase reflectivity (J Q Xi et al. Opt. Lett. 2006, 31(5), 601-603; E F Schubert et al. Phys. Status Solidi (b), 2007, 244(8), 3002-3008). However, these oblique deposition methods cannot achieve precise control of refractive index. Another potential fabrication technique to improve control of refractive index is atomic layer deposition (ALD), wherein a self-limiting chemical interaction between the reactants enables thin layer deposition of materials in the range of 1 angstrom (M. Lesleka et al. Angewandte Chemie, 2003, 42(45), 5548-5554; J Lu et al. Surf Sci. Rep., 2016, 71(2), 410-472; J G Baker et al. Chem. Mater., 2020, 32(5), 1925-1936). Recent work achieved control in refractive index by using alternate layers of Al₂O₃ and TiO₂, grown by Atomic Layer Deposition, which results in a miniscule change in refractive index for a corresponding increase in number of cycles of Atomic Layer Deposition, and the refractive index is depicted only as a function of number of growth cycles through this research. Recent research using ALD on sacrificial 3D polymer nanostructure templates have demonstrated low-index materials with the index as low as 1.025 (SI Zaitsu et al. Appl. Phys. Lett., 2002, 80(14), 2442-2444; DE Jung et al. ACS Appl. Nano Mater. 2023, 6(3), 2009-2019; XA Zhang et al. Adv. Funct. Mater., 2015, 25(42), 6644-6649). While existing work have demonstrated the fabrication of material with index close to 1, it is still challenging to precisely control the index at the sub 1×10⁻³ level.

An aim of this work is to demonstrate precise control of refractive index in low-index nanolattice material. This approach uses an array of nanospheres as a phase mask to create a 3D nanostructure, which then serves as a template for ALD to coat a conformal thin film on the structure surface. Upon resist removal, the resulting nanolattice structure is highly porous with low index. By controlling the unit-cell geometry of the 3D nanostructure template during lithography and the shell thickness during ALD, the index of the nanolattice element can be precisely controlled. The indices of the fabricated samples are measured using spectroscopic ellipsometry with a Cauchy isotropic model to investigate the effect of nanolattice geometry and ALD thickness. The fabricated geometry was modelled using Maxwell-Garnett effective medium theory, which agrees well to experimental data. The number of ALD cycles is carefully monitored and varied to achieve an index resolution in the range less than 1×10⁻³. This result demonstrates that the refractive index of nanolattices can be precisely controlled and can find applications in nanophotonics, metasurfaces, and optoelectronic devices.

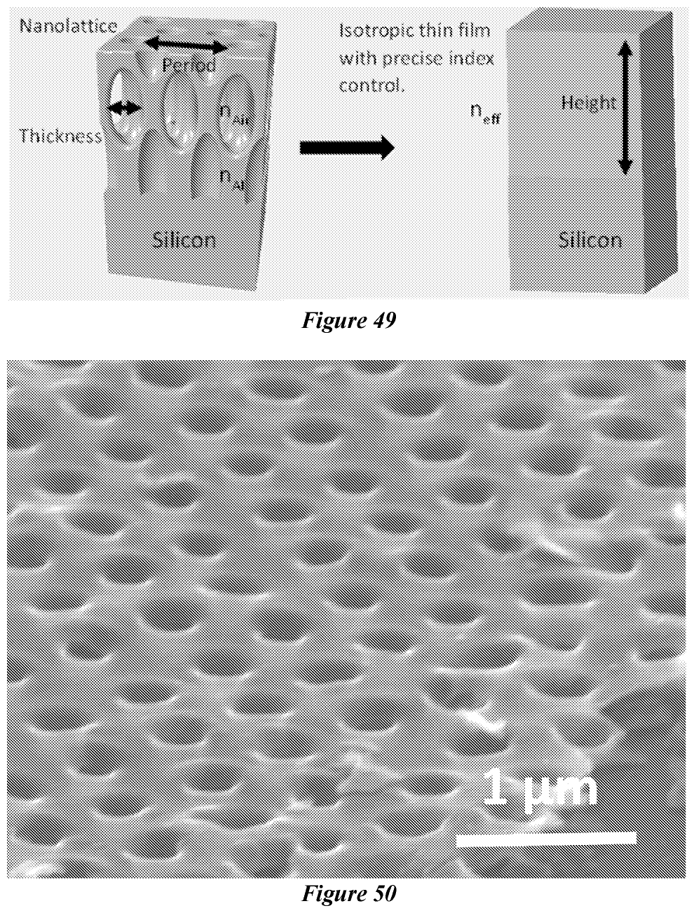

Experimental Methodology. The proposed nanolattice film with refractive index that can be precisely controlled is illustrated in FIG. 49. The periodic structure comprises tubular elements with thin shells, the geometry of which controls the porosity and effective refractive index of the film. This work will examine the effects of the lattice unit cell, period, and shell thickness on the measured index. The nanolattice is fabricated using a combination of colloidal phase lithography and ALD. Silicon wafers are spin-coated with an anti-reflective coating (Brewer Science i-con-7) of 100 nm thickness to reduce back reflection, followed by 300-1000 nm thickness of positive photoresist (Sumitomo PFI-88). Polystyrene nanospheres (Polysciences,) in aqueous solution are diluted in ethanol and dispersed over the surface of water to form a hexagonal closed packed structure through Langmuir-Blodgett assembly. Nanospheres of diameters 750 nm, 500 nm and 390 nm are used in the experiments. The colloidal assembly is transferred on top of the silicon substrate with photoresist, which is exposed using 325 nm HeCd laser. This is followed by removal of nanospheres and development using developer (Microposit CD-26), resulting in 3D photoresist nanostructures. Finally, the samples are subjected to ALD to form layers of Al₂O₃ with nominal thickness of 21 nm, and the photoresist is removed by post-exposure baking in furnace at 550° C. with a ramp rate of 1° C./hr. The samples are dwelled at this high temperature for 2 hours before cooling to room temperature at a rate of 5° C./hr.

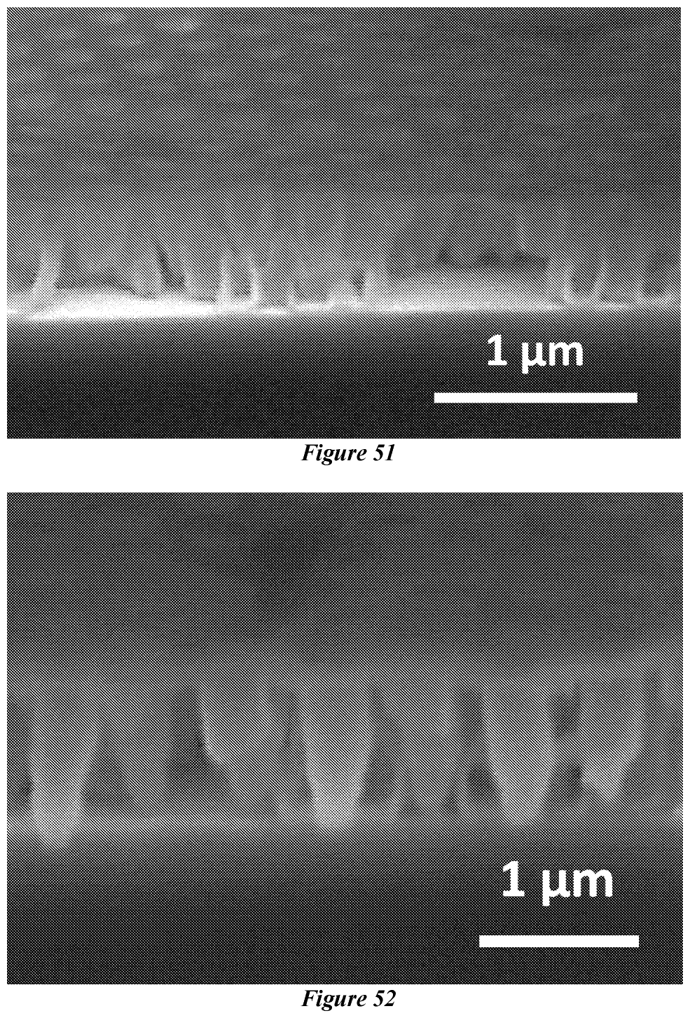

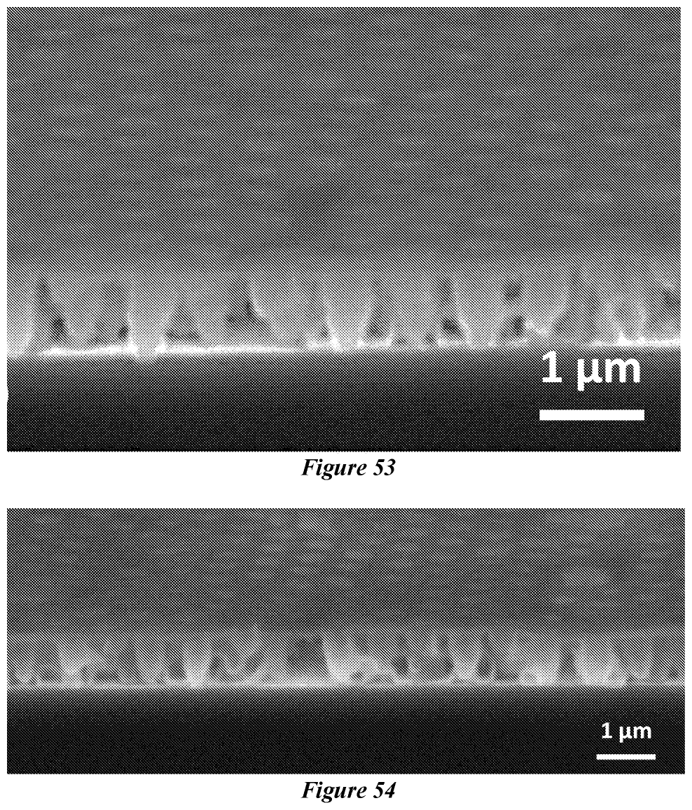

The cross-section SEM images of the fabricated samples are shown in FIG. 50-FIG. 54 depicting the fabrication of desired nanostructures on a large scale over silicon substrate.

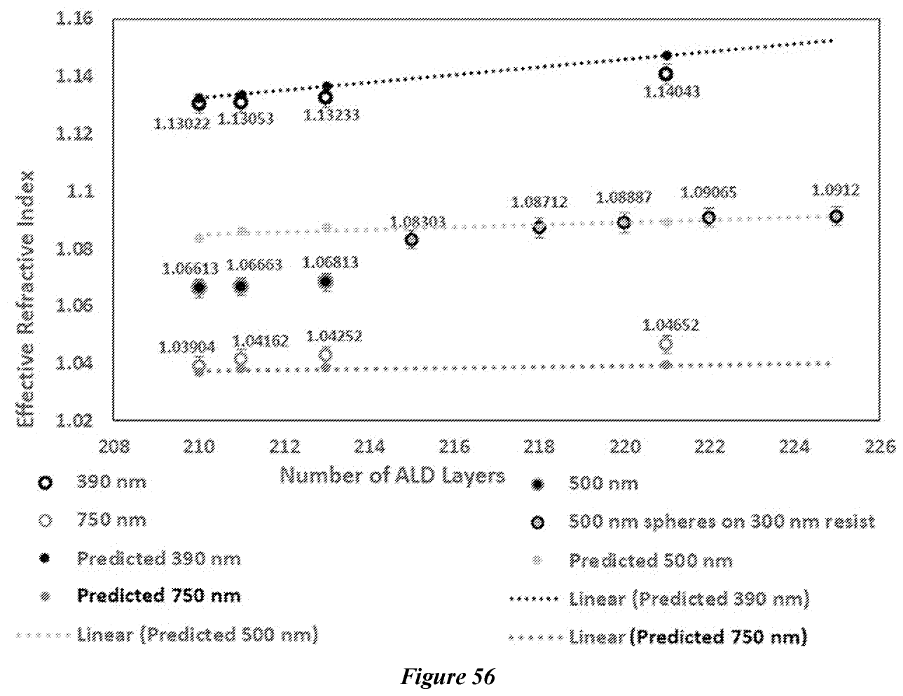

Theoretical Modelling of Nanolattice Index. A model of the nanolattice material based on effective medium theory is constructed to predict the film index. It becomes useful to model these parameters to identify the refractive indices of the values for a given set of structural constants. Reverse engineering the model to figure out the refractive indices that can be obtained would enable in the fabrication of low index samples, which has profound applications in the field of optics, and a continuous set of varying refractive indices can be produced by using specific parameters. The nanolattice samples comprise a periodic array of tubular elements where the unit-cell geometry depends on the lithography conditions. The lattice can be non-cubic and anisotropic in nature, and the initial models are based on a Cauchy isotropic model. The refractive index values can increase with the increase in thickness of the aluminum oxide shell, and this increase is facilitated by the increase in number of ALD cycles as shown in FIG. 56. This work examines nanolattice samples with different number of cycles of ALD layers from 215 to 225 cycles, corresponding to an aluminum oxide thickness of from 215 to 225 Angstroms. The period of the structure can also have an effect, as larger period with constant shell thickness results in higher porosity and lower index. For convenience, all the values of refractive indices will be at 632 nm wavelength; aluminum oxide has a refractive index of about 1.67 at 632 nm, and the other parts of the nanostructure is made of air, which has a refractive index of 1. Thus, depending on the number of cycles of ALD, the effective refractive index of the structure vanes. The Maxwell-Garnett (MG) model is used to predict the effective refractive index n_{eff}, as given by,

$$β = ( \frac{{n}_{{e}_{ff}}^{2} - 1}{{n}_{eff} + 2} ) / ( \frac{{n}_{m}^{2} - 1}{{n}_{m}^{2} + 2} ) \qquad ( 1 )$$

where nₘ is the index and β are the index and volume fraction ratio of the solid phase, respectively. The volume fraction is approximated by considering the nanolattice structures to be perfect cylinders and are 0.58% and 0.64% for the variation of refractive index between 1.0830 and 1.0912. The volume fraction is again an approximation since there is a structural collapse due to the photoresist baking in the oven, which deviates from the cylindricity. Apart from that, there could also be formation of cracks or spaces between the nanosphere arrays, leading to deviations. The values of β were found to vary between 0.1312 and 0.1439, which is then plotted against the volume fraction. Additionally, a curve fit is performed, to incorporate the influence of volume fraction, and thereby the size of the nanospheres and height of photoresist used. Finally, the model is used to predict the theoretical effective refractive index of a nanostructure, given the cylindrical diameter and height, which is predicted from the MG model.

Results and Discussion. The refractive indices of the fabricated nanolattices with observed for varying cycles of Atomic Layer depositions using Cauchy model tracking isotropic behavior and the plot depicting the influence of number of cycles of ALD on effective isotropic refractive index is shown in FIG. 56. All the refractive index values taken and compared in the results are taken at a wavelength of 632 nm. Testing of thickness (nm), and refractive index values were obtained using spectroscopic ellipsometer with angle of light incidence at 70 degrees, and wavelengths varying between 400 nm and 1600 nm. Cauchy model was employed in the ellipsometry with both isotropic and anisotropic models being used. While using a Cauchy model for isotropic behavior analysis, the model is placed over a thin layer of Silicon dioxide to incorporate the changes caused by oxidation of bare poly-silicon wafer, which is innately reactive to oxides in pure form. The samples were tested ten times at different spots on the sample to check the confidence levels and measurement error for the refractive index and thickness values. Standard deviation was found to be 0.00377, which is well below the 5% error bar. The samples used had aluminum oxide thickness values ranging from 215 Angstroms (215 cycles) to 225 Angstroms (225 cycles), as each cycle on the Atomic Layer Deposition corresponds to one Angstrom thickness deposition of the layer.

The isotropic model was explored using the ellipsometer, wherein the model showed no variations between the refractive index values in X, Y, and Z directions. The index values vary between 1.08303 and 1.09120 for the difference of 10 Angstroms, and thereby an index control of 0.000409 is achievable for a single cycle of Atomic Layer Deposition corresponding to one Angstrom of aluminum oxide.

The thickness values were desired to be in the range of about 310 to 325 nm whereas the observed values were in the range of 217 to 245 nm, and this reduction in thickness can be explained by the reduction in height due to collapsing of the structures when they are heated in the oven, and these can be prevented by reducing the ramp up rate of temperature to prevent the structures from being subjected to sudden increments in temperature (R Huang et al. Sci. Rep. 2014, 4, 7051). The ramp up rate used for the current samples is about 1° per minute, leading to a heating time about 8 hours and 45 minutes. Further reduction in ramp up rates would have resulted in corresponding increase in heating time to achieve the ramp high temperature of 550° C. Similarly, the thickness of the silicon oxide surface below the Cauchy layer also varied between 0 nm to 10 nm, and these variations are due to the variety of oxide environments the samples are placed in while storage and while characterization. Another set of constants that were fit to the curve to achieve the best accuracy of prediction of refractive indices are the An, Bn, and Cn constants (Cauchy model constants). These constants were also not found to vary by much between the small addition of aluminum oxide thickness by ALD, and the values for An, Bn, and Cn were in the range of 1.062, 0.009, 0.0005 respectively. These constants determine the type of curve generated by the ellipsometer to fit the actual experimental data. From the information for the variation of Effective refractive index for given number of ALD cycles, it is observed that the slope between the X and Y axes gradually reduces with the increase in number of cycles, indicating that the effect of thickness of aluminum oxide layer saturates after certain thickness in effective refractive index.

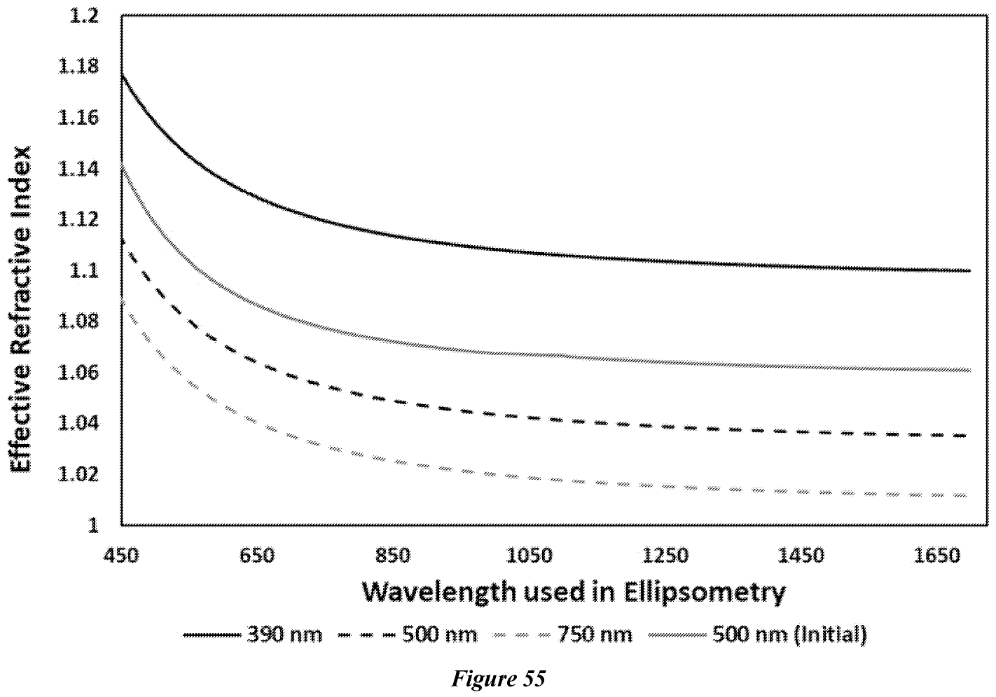

Validation of Isotropic Behavior Modelling. The results obtained from the previous experiments have been validated by fabricating new set of samples with variations in number of cycles for Atomic Layer Deposition, and their corresponding variations in thickness, MSE values and effective refractive indices are also measured. The refractive indices corresponding to number of cycles of ALD, for different diameters of nanospheres used in near field phase masks have been plotted for comparison in FIG. 56. Further, the variation of refractive indices corresponding to incident light wavelength in ellipsometry have been plotted in FIG. 55. The samples contain an 800 nm thick photoresist coating over the anti-reflective coating, and thereby increases the thickness of the sample. In addition to this, the ALD is performed for about 21 nm thickness, and then the photoresist was removed from the samples. The ultrasonication times and resist removal process did not vary, as these processes were sufficient to effectively remove the deposited nanospheres and the resist, respectively.

The thickness values of the samples were found to have a maximum deviation of 9.58% and the lowest observed value was for the 213 cycles sample in case of 750 nm diameter sphere deposition. This thickness could be due to the collapse of structures in the sample. Moreover, the effect of structural collapse increases with the height of the photoresist, wherein the taller resist produces thin-walled structures with high aspect ratio. The effect of thermal expansion can cause the atoms within the nanostructures to vibrate and thereby causes changes in the distance between nanostructures. This change in distance causes plastic deformation, which can lead to collapse. The sample aspect ratio increases when smaller nanospheres are used for lithographic phase masks, leading to higher structural collapse. The MSE values were also found to be in average range of 60 to 65, which can be attributed to the noise from experimental data due to the defects in the arrangement of nanostructures, and sometimes due to the influence of multiple layers and structures. The nanospheres can get aggregated into multilayers, which results in the formation of two or more layers of this structures, which can cause deviations in the change in polarizations detected by ellipsometer. The structure also contains very thin layer of native oxide silica formed beneath the Cauchy layer, which could also affect the degree of polarization of high aspect ratio structures. Thus, as a common trend between the samples of diameters 750 nm, 500 nm, and 390 nm, the thickness values are found to deviate between 9.58 and 13.12% and the MSE values are varying between 43.7 and 77.2. With regards to the refractive indices for corresponding to number of layers of ALD, it can be seen that there is an increase in the refractive index range between 1.0394, 1.06613 and 1.13022 for 750 nm, 500 nm and 390 nm nanospheres. This increase in refractive index with reduction of nanosphere sizes is due to the corresponding increase in surface to volume ratio, as more structures are formed in the same substrate size (H Chen et al. Langmuir, 2008, 24(10), 5233-5237). This leads to increase in surface energy of material, which correspondingly changes the electronic structure of the photoresist leading to changes in optical properties. Another reason for the increase in refractive index with reduction in nanosphere sizes is the quantum confinement effect, where the electronic properties of the material changes with size at nanoscale range. When the material is confined to a very small scale as with the ALD in very high aspect ratio structures, the electrons within the material become quantized, and the energy levels become discrete, leading to increase in refractive index (J S Weiner, Appl. Phys. Lett., 1987, 50, 842-844). The formation of discrete energy levels increases the density of electric charge in the material, and further results in stronger interaction between the electromagnetic field and the material, resulting in a higher shift in polarization and corresponding high change in refractive index. The values of refractive indices are fluctuating with high errors at very low wavelengths, owing to this quantization of energy levels, and corresponding increase in interaction between the EM field and ALD material.

Finally, reducing the sizes of nanospheres increase the packing density and dielectric constant of the medium. The measured nanolattice index increases towards the refractive index of Al₂O₃, which is about 1.67 for 632 nm, as the lattice period. The presence of two different materials such as aluminum oxide and air, and the ability to deposit aluminum oxide facilitates the control of refractive indices to the order of 1×10⁻⁴. It can also be observed that increasing the thickness of deposition of photoresist does not influence the variation of refractive index, as the 800 nm height structures for 500 nm particles have refractive indices of 1.06613, 1.06663, 1.06813 for 210, 211 and 213 cycles of ALD respectively. This is close to the refractive index values of about 1.08 for 500 nm spheres used with 300 nm resist height. The effect can be attributed to the fact that the photoresist is a sacrificial template and is removed before the measurements of effective refractive index. The lowest effective refractive index obtained is for 210 cycles with 750 nm diameter, with a value of about 1.03904, and the highest index was obtained at 221 cycles, thereby enabling an index control in the order of 7.48×10⁻⁴. Similarly, for 500 nm near field phase masks, an index control of 5×10⁻⁴ is achieved, and for 390 nm masks, about 9.28×10⁻⁴ was achieved. Finally, it is noted that the analytical model can successfully predict the values of effective refractive indices using the relationship between normalized refractive indices and volume fraction calculated from the input of nanosphere diameters, and photoresist heights. This accurate prediction has great implications for calculation of desired volume fraction given the material for deposition and the target refractive index, which can be achieved using the proposed series of steps involving UV lithography and Atomic Layer Deposition process. These design and prediction capabilities result in fabrication of nanolattices with desired effective refractive index in the order of 1×10⁻⁴.

Conclusions. Herein, 3D nanocylinders arranged with hexagonal closed packing and having a shell thickness of 21 nm to 22.2 nm are fabricated and characterized for optical constants like refractive index. It is observed that an increase in number of cycles of Atomic Layer Deposition results in a corresponding increase in refractive index, due to the increase in density of structures, and the effective dielectric constant shifting to higher values with increase in amount of aluminum oxide deposition. A model has been created to understand the trend using Maxwell-Garnett equation, and calculations are made to predict the refractive index of 3D nanostructures using the model. Moreover, validation of these predicted calculations is performed by fabricating samples with varying photoresist thickness compared to the initial samples, and by varying the diameters of nanostructures. There are no significant changes observed by increasing the height of photoresist on the nanostructure, whereas a significant trend is observed in refractive index values with corresponding changes in diameter of nanospheres used for near field masks before lithography for these samples. This is attributed to the increase in surface to volume ratio between the aluminum oxide and air phases of the nanostructure. Finally, the research outputs successful methods to fabricate nanostructures with differences in refractive indices in the order of 0.000409 for sample with resist height of 300 nm and cylinder diameter of about 500 nm. For samples with 800 nm resist height, the index variation per cycle yielded to 7.48×10⁻⁴ for 750 nm cylinder diameter, 5×10⁻⁴ for 500 nm diameter, and 9.28×10⁻⁴ for 390 nm diameter. The accuracy in fabrication and control of refractive indices opens several possibilities for applications in photonic crystals specifically in improving the efficiency of Bragg reflectors.

### Example 6—Ultra Precise Index Control of Nanolattices

Described herein is the ultra precise control of effective refractive indices of nanolattices by depositing very thin layers with the process called Atomic Layer Deposition. This concept is demonstrated in prototypes where the nanolattice samples are fabricated with 210 to 221 layers of thickness using ALD. The variation in effective refractive index is measured using the technique called Spectroscopic Ellipsometry, and the variation in refractive index is noted, with corresponding change in number of cycles of ALD. The standard deviation of the refractive indices measured is validated by measuring at multiple points on the sample, followed by taking root mean squared of the measurements. This enables the samples to have a very minimal refractive index difference in the order of 0.0001. The fabrication technique involves using 3D colloidal lithography to define a periodic nanostructure in photoresist. After this is the lithography process (in this case UV lasers are used), followed by development using any developers. Subsequently, the nanolattices are created using Atomic Layer Deposition process, which helps in creating thin shelled structures, and then the structure is placed into vacuum furnace or dissolved using solvents or subjected to oxygen plasma etching to remove photoresist. Only the ALD oxide shell remains, and this reveals the nanolattice, which is about 20 nm thick. These are measured using ellipsometry for the best fit of parameters, using Cauchy Model for isotropic/anisotropic behavior.

The ability to simultaneously achieve low refractive indices and precise index control has not been demonstrated previously. The ability to precisely control the indices in the order of 0.0001 can enable numerous applications in gradient refractive index optics, nanophotonics, and multilayer waveguides, and in improving the efficiency of transmittance in photonic integrated circuits. This can enable highly precise control of photonic bandgaps in nanostructures. Apart from that, the ability to control index also results in accurate development of optical sensors and functional Bragg reflectors. Overall, this enables better performance of photonic integrated circuits by enhancing the sensitivity of lattice structures.

The methods described herein can control the refractive indices precisely in the order of 0.0001. The methods can also accurately predict the effective refractive indices and fabricate nanolattices for the desired index. The methods can also control the optical properties (photonic bandgap, waveguide efficiency, etc.) of nanolattices effectively.

Current technologies can be used to fabricate low index, but precise control of refractive index in the order of 10⁻⁴ has not been demonstrated previously. Apart from that, the MATLAB model opens possibilities for accurate prediction of geometric and fabrication parameters for a desired refractive index.

Currently, the samples are fabricated in small scale wafers. The process can be scaled up using scalable nanosphere deposition methods, such as a Roll-to-Roll phase mask assembly equipment.

The methods described herein allow researchers to fabricate samples with a desired refractive index, since the methods can predict the thickness of resist required to be deposited, and the size of nanospheres to be used in phase masks, to accurately produce a specific refractive index in the order of 0.0001.

### Example 7—Ultra Precise Index Control of Nanolattices

Described herein are methods that can control the refractive indices precisely in the order of 0.0001. Also described herein are methods that can accurately predict the effective refractive indices and fabricate nanolattices for the desired index.

Other methods do not provide an accurate control in index as low as 0.0001. Moreover, the proposed technology is for periodic structures over a large scale, which makes it suitable for photonic integrated circuits.

The samples fabricated from the methods proposed result in precise control on the way which light is manipulated through the structures. The lattices can be controlled in height and radius of the cylindrical structures, and this directly affects the change in refractive index of the samples. As a result, parameters corresponding to desired refractive index can be modeled and fabricated to an ultra-high precision.

The relationship developed from the model results in prediction of sample refractive indices to the order of 0.0001. Samples can be fabricated to ultra-high precision.

The results of the research enable about 100× better control of refractive index compared to the existing methods resulting in better efficiency in photonic manipulation. This opens a variety of applications in optoelectronics, and in photonic crystal fabrication.

Applications and markets for this technology include, but are not limited to, photonic devices, semiconductor equipment and devices, aerospace and defense applications such as those focusing on stealth technology, and 3D display technology.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The methods of the appended claims are not limited in scope by the specific methods described herein, which are intended as illustrations of a few aspects of the claims and any methods that are functionally equivalent are intended to fall within the scope of the claims. Various modifications of the methods in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

1. A composite material comprising:
a porous periodic nanolattice layer; and
a continuous layer;
wherein the continuous layer is disposed on the porous periodic nanolattice layer;
wherein the porous periodic nanolattice layer has a first refractive index and the continuous layer has a second refractive index;
wherein the first refractive index and the second refractive index are different;
wherein the porous periodic nanolattice layer comprises a plurality of pores defined by a nanolattice formed of hollow members, the plurality of pores being arranged in an ordered array, such that the plurality of pores are periodic; and
wherein the hollow members comprise a wall defining an interior void space.

2. The composite material of claim 1, wherein:
the first refractive index is from 1 to 1.35,
the second refractive index is from 1 to 4;
the difference between the first refractive index and the second refractive index is 0.5 or more;
or a combination thereof.

3. (canceled)

4. (canceled)

5. The composite material of claim 1, wherein the porous periodic nanolattice layer has a porosity of 90% or more.

6. The composite material of claim 1, wherein the plurality of pores have an average pore size of from 10 nanometers (nm) to 1 micrometer (μm).

7. The composite material of claim 1, wherein the plurality of pores have a periodicity of from 1 nanometer (nm) to 1 micrometer (μm).

8. (canceled)

9. (canceled)

10. The composite material of claim 1, wherein the wall comprises a metal oxide.

11. The composite material of claim 1, wherein the wall comprises Al₂O₃, ZnO, SiO₂, TiO₂, or a combination thereof.

12. (canceled)

13. The composite material of claim 1, wherein the wall has an average thickness of from 1 nanometer (nm) to 250 nm.

14. (canceled)

15. (canceled)

16. The composite material of claim 1, wherein the porous periodic nanolattice layer has an average thickness of from 1 nanometer (nm) to 1 micrometer (μm); the continuous layer has an average thickness of from 1 nanometer (nm) to 1 micrometer (μm); or a combination thereof.

17. The composite material of claim 1, wherein the porous periodic nanolattice layer has a mechanical stiffness sufficient to support the continuous layer, the continuous layer has a mechanical stiffness sufficient to support the porous periodic nanolattice layer, or a combination thereof.

18. (canceled)

19. The composite material of claim 1, wherein the continuous layer comprises a metal oxide.

20. The composite material of claim 1, wherein the continuous layer comprises TiO₂, Al₂O₃, ZnO, or a combination thereof.

21.-24. (canceled)

25. The composite material of claim 1, further comprising a substrate, wherein:
the porous periodic nanolattice layer is disposed on the substrate, such that the porous periodic nanolattice layer is sandwiched between the substrate and the continuous layer; or
the continuous layer is disposed on the substrate, such that the continuous layer is sandwiched between the substrate and the porous periodic nanolattice layer.

26. (canceled)

27. The composite material of claim 1, further comprising one or more additional layers, wherein:
the one or more additional layers are disposed on the porous periodic nanolattice layer, such that that the porous periodic nanolattice layer is sandwiched between the continuous layer and the one or more additional layers; or
the one or more additional layers are disposed on the continuous layer, such that the continuous layer is sandwiched between the porous periodic nanolattice layer and the one or more additional layers;
and wherein the continuous layer and/or the porous periodic nanolattice layer independently have a mechanical stiffness sufficient to support the one or more additional layers.

28.-31. (canceled)

32. The composite material of claim 1, wherein the composite material comprises a stack comprising a plurality of alternating layers of the porous periodic nanolattice layer and the continuous layer.

33.-37. (canceled)

38. The composite material of claim 1, wherein the composite material reflects one or more wavelengths of the solar spectrum with a reflectivity of 80% or more.

39. (canceled)

40. The composite material of claim 1, wherein the composite material has a reflectance peak and the FWHM of the reflectance peak is 300 nm or more.

41. (canceled)

42. (canceled)

43. (canceled)

44. A method of making the composite material of claim 1, the method comprising:
a. forming a patterned layer;
b. depositing a first material on the patterned layer, thereby forming a coated patterned layer;
c. depositing a buffer material layer on the coated patterned layer, thereby forming a planarized layer;
d. depositing a continuous layer on the planarized layer; and
e. removing the buffer material layer and the patterned layer, thereby forming the composite material.

45.-64. (canceled)

65. A method of use of the composite material of claim 1, wherein the method comprises using the composite material in an optical device, an electronic device, an optoelectronic device, a photonic application, an electronic application, a thermal application, a mechanical device, an energy dissipation device, an energy storage device, a spring system, a filter device, or a combination thereof.

66.-71. (canceled)

72. An article of manufacture and/or a device comprising the composite material of claim 1, wherein the article and/or device comprises an optical device, an electronic device, an optoelectronic device, a mechanical device, an energy dissipation device, an energy storage device, a spring system, a filter device, or a combination thereof.

73.-76. (canceled)
